(19) United States
(12) Patent Application Publication
(10) Pub. No.: US 2015/0174914 A1
(43) Pub. Date: Jun. 25, 2015

(54) DRAWING APPARATUS AND CONTROL METHOD FOR DRAWING WITH DRAWING APPARATUS

(71) Applicant: CASIO COMPUTER CO., LTD., Tokyo (JP)

(72) Inventor: Hiroyasu BITOH, Tokyo (JP)

(73) Assignee: CASIO COMPUTER CO., LTD., Tokyo (JP)

(21) Appl. No.: 14/576,024

(22) Filed: Dec. 18, 2014

(30) Foreign Application Priority Data
Dec. 20, 2013 (JP) 2013-263161

(51) Int. Cl. B41J 2/49

(52) U.S. Cl. CPC B41J 2/49

(57) ABSTRACT

A drawing apparatus includes a drawing head and a stirring unit. At least one drawing tool is held by the drawing head. The drawing tool includes a fluid material container to contain a fluid material and performs drawing on a drawing target with the fluid material. The stirring unit performs a stirring operation to stir the fluid material in the fluid material container of the drawing tool held by the drawing head by changing a tilt angle of the drawing tool.

### CROSS-REFERENCE TO RELATED APPLICATIONS

This application is based upon and claims the benefit of priority from the prior Japanese Patent Application No. 2013-263161, filed on Dec. 20, 2013, the entire contents of which are incorporated herein by reference.

### BACKGROUND OF THE INVENTION

1. Field of the Invention

The present invention relates to a drawing apparatus and a control method for drawing with a drawing apparatus.

2. Description of the Related Art

Nail printing apparatuses to print nail designs on nails have been known. A nail printing apparatus having a printing head for ink-jet printing is disclosed in Japanese Unexamined Patent Application Publication (Translation of PCT Application) No. 2003-534083.

Such an apparatus allows users to enjoy nail designs easily without utilizing nail salons.

Inks containing coloring materials, such as pigments, having a relatively large specific gravity or relatively large particle size, can produce colors well for nail prints.

An ink-jet printing head, which ejects fine ink drops from nozzles, however, can only use limited types of inks because the hole diameter of the nozzles is relatively small.

Plotter printing apparatuses that include a drawing head with drawing pens which are held are also known. For a plotter printing apparatus, which uses pens, there are less restrictions on the inks to be used. A plotter printing apparatus used as a nail printing apparatus could use various types of inks, achieving nail prints with colors developed well.

If ink in a pen contains a coloring material (e.g., white pigment) or particles (e.g., glitter) having a relatively large specific gravity or relatively large particle size, the coloring material and particles in the ink tend to settle and aggregate, causing clogging of the ink. If a pen is not shaken to stir the ink before use, the coloring material in the ink settles or aggregates. This may fail to produce intended colors and cause the ink to clog or prevent the ink from coming out smoothly.

Even if a pen is shaken to stir the ink before the pen is held by a nail printing apparatus, the coloring material and particles of the ink in the pen gradually settle and aggregate as time goes on. Specifically, if a long time has elapsed before the start of drawing or a long time is required before the completion of drawing to produce a lot of drawings, it may become difficult to produce an intended color, and the ink may clog or may be prevented from smoothly coming out due to the settlement or aggregation.

### BRIEF SUMMARY OF THE INVENTION

The present invention provides a drawing apparatus to perform drawing on a drawing target with a drawing tool containing fluid material. The drawing apparatus of the present invention advantageously prevents settlement and aggregation of coloring material and particles in fluid material, and achieves high-definition drawings with intended colors even if the fluid material in the drawing tool contains coloring material and particles that could be prone to settle and aggregate.

According to a first aspect of the present invention, there is provided a drawing apparatus including: a drawing head to hold at least one drawing tool, the drawing tool including a fluid material container to contain a fluid material and performing drawing on a drawing target with the fluid material; and a stirring unit which performs a stirring operation to stir the fluid material in the fluid material container of the drawing tool held by the drawing head by changing a tilt angle of the drawing tool.

According to a second aspect of the present invention, there is provided a control method for drawing with a drawing apparatus, the method including: holding at least one drawing tool with a drawing head, the drawing tool including a fluid material container to contain a fluid material and performing drawing on a drawing target with the fluid material; performing a stirring operation to stir the fluid material in the fluid material container of the drawing tool held by the drawing head by changing a tilt angle of the drawing tool; and performing the drawing on the drawing target with the drawing tool through the drawing head after the stirring operation is performed.

### BRIEF DESCRIPTION OF THE SEVERAL VIEWS OF THE DRAWING

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a front view of a drawing apparatus in a first embodiment;

FIG. 2 is a sectional side view of the drawing apparatus along the line II-II of FIG. 1;

FIG. 3 is a sectional view along the line of FIG. 1;

FIGS. 4A to 4C are enlarged views of a carriage and a pen held by the carriage in a drawing state, and more specifically, FIG. 4A is a side view of the carriage and pen, FIG. 4B is a top view of the carriage and pen, seen from the direction of arrow b of FIG. 4A, and FIG. 4C is a front view of the carriage and pen, seen from the direction of arrow c of FIG. 4A;

FIG. 5 is a block diagram showing the principal control configuration of the drawing apparatus according to the first embodiment;

FIG. 6 is a front view of a drawing apparatus in a second embodiment;

FIG. 7 is a sectional side view of the drawing apparatus in FIG. 6;

FIGS. 8A to 8C are enlarged views of a drawing head of the second embodiment, and more specifically, FIG. 8A is a top view of the drawing head, FIG. 8B is a front view of the drawing head, seen from the direction of arrow b of FIG. 8A, and FIG. 8C is a side view of the drawing head, seen from the direction of arrow c of FIG. 8A;

FIG. 9A shows the drawing head of the second embodiment tilted between 95° and 47.5°, and FIG. 9B shows the drawing head of the second embodiment tilted between 95° and −95°;

FIGS. 10A to 10C are enlarged views of a drawing head of a third embodiment, and more specifically, FIG. 10A is a top view of the drawing head, FIG. 10B is a front view of the drawing head, seen from the direction of arrow b of FIG. 10A, and FIG. 10C is a side view of the drawing head, seen from the direction of arrow c of FIG. 10A;

FIG. 11 shows the drawing head of the third embodiment tilted between 0° and 95°;

FIGS. 12A to 12C are enlarged views of a drawing head of a modification of the embodiments, and more specifically, FIG. 12A is a top view of the drawing head, FIG. 12B is a front view of the drawing head, seen from the direction of arrow b of FIG. 12A, and FIG. 12C is a side view of the drawing head, seen from the direction of arrow c of FIG. 12A; and

FIG. 13 shows the drawing head of FIG. 12 tilted between 0° and 95°.

### DETAILED DESCRIPTION OF THE INVENTION

Embodiments of a drawing apparatus according to the present invention will now be described in detail with reference to the drawings.

The embodiments described below have various limitations which are technically preferable to carry out the present invention. The scope of the present invention, however, is not limited to the embodiments below and the examples shown in the drawings.

The drawing apparatuses of the embodiments perform drawing on nails of fingers (including thumbs) as a drawing target. The drawing target, however, is not limited to nails of fingers but may be nails of toes.

### First Embodiment

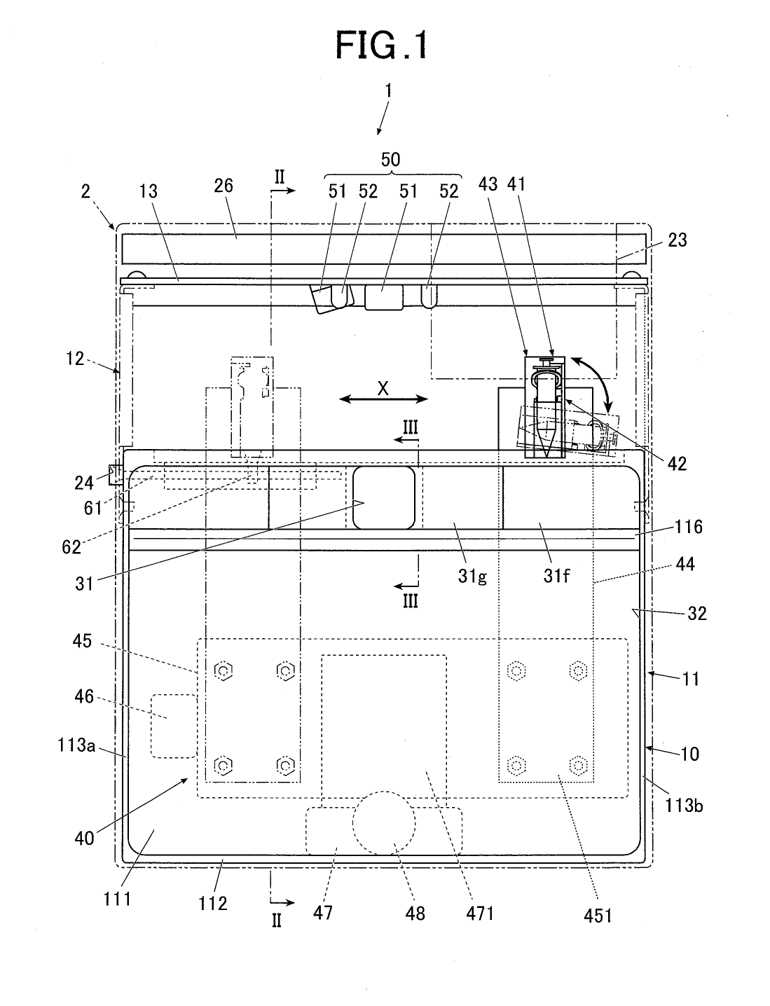

A drawing apparatus 1 of a first embodiment of the present invention will now be described with reference to FIGS. 1 to 5.

FIG. 1 is a front view of the drawing apparatus 1 in this embodiment.

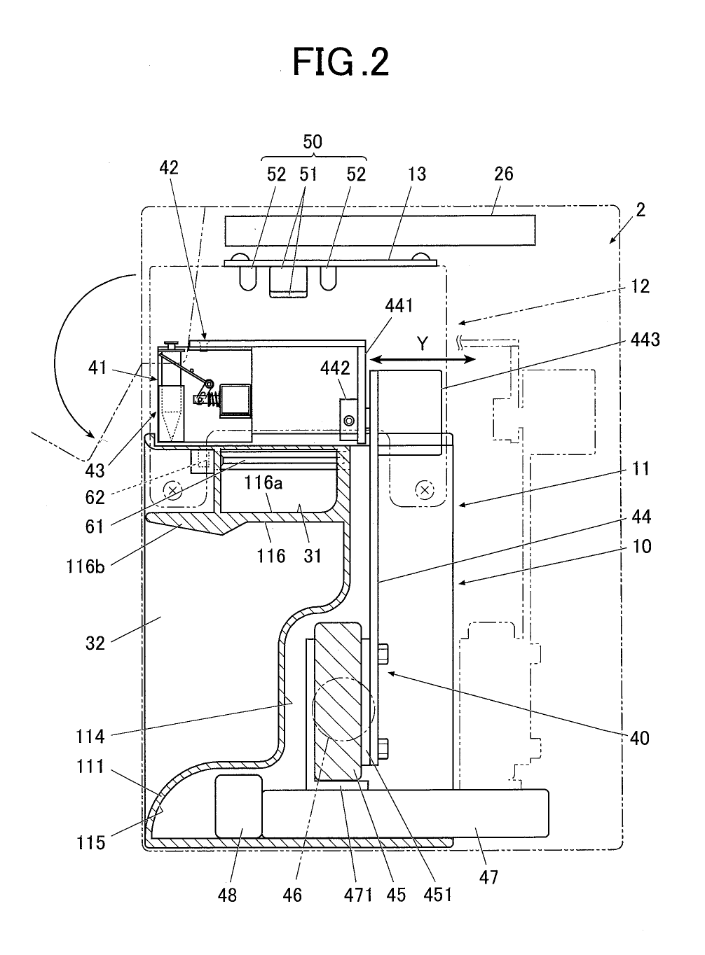

FIG. 2 is a sectional side view of the drawing apparatus 1 along the line II-II of FIG. 1.

As shown in FIGS. 1 and 2, the drawing apparatus 1 is a nail printing apparatus to perform drawing on nails of fingers and includes a case body 2 and an apparatus body 10 contained in the case body 2.

In FIGS. 1 and 2, the case body 2 is indicated by two-dot chain lines.

A cover 23 for pen replacement is disposed at one end part of the upper front side of the case body 2. The cover 23 can be opened and closed so that a pen (drawing tool) 41 of a drawing unit 40, described later, can be replaced.

The cover 23 for pen replacement can turn about a hinge, for example, from a closing state to an opening state as shown in FIG. 2.

One lateral face (left face in FIG. 1 in this embodiment) of the case body 2 has a medium insertion/output opening 24 at the position corresponding to a pen warm-up section 61, which is described later. A drawing medium (not shown) placed on the pen warm-up section 61 can be replaced through the medium insertion/output opening 24.

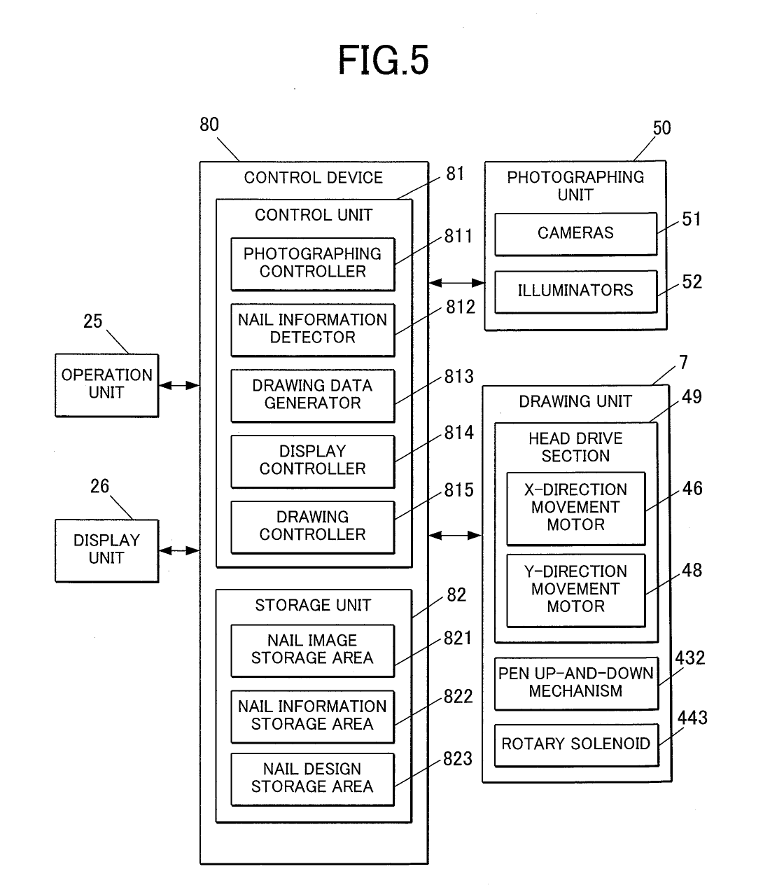

An operation unit 25 (see FIG. 5) is disposed on the upper surface (top board) of the case body 2.

The operation unit 25 is an input unit to receive various inputs from a user.

The operation unit 25 includes operation buttons (not shown) for various inputs, such as an electrical power switch button to power on the drawing apparatus 1, a stop switch button to stop its operation, a design selection button to select a design image to be drawn on nails T, and a drawing switch button to instruct start of drawing.

A display unit 26 is disposed on the upper surface (top board), almost in its center, of the case body 2.

The display unit 26 is constituted of a liquid crystal display (LCD), an organic electroluminescence display (organic EL), or another flat-panel display.

In the present embodiment, the display unit 26 displays nail images obtained by photographing a printing finger U1 (i.e., finger images each including the image of nail T), the image of the outline of the nail T included in the nail image, a design selection screen for selecting a design image to be drawn on a nail T, a thumbnail image for checking a design, an instruction screen to provide various instructions, and the like, as appropriate.

A touch panel may be integrally formed on the surface of the display unit 26. In this case, various selections and instructions can be made through touch operations of the surface of the touch panel with a fingertip, for example. A stylus pen and other stick writing implements having a sharp end may also be used for the touch operations of the surface of the display unit 26 for various inputs.

The apparatus body 10, which is substantially formed in the shape of a box, includes a lower machine casing 11 disposed at the lower part in the case body 2, and an upper machine casing 12 disposed above the lower machine casing 11 and at the upper part in the case body 2.

The lower machine casing 11 will now be described.

The lower machine casing 11 includes a back plate 111, a bottom plate 112, a pair of side plates 113a and 113b, an X-direction movement stage storage part 114, a Y-direction movement stage storage part 115, and a dividing wall 116.

The lower ends of the side plates 113a and 113b are connected to the both ends of the bottom plate 112, respectively, so that the side plates 113a and 113b are upright with respect to the bottom plate 112.

As shown in FIG. 2, the lower part of the back plate 111 is caved in in two steps toward the front (i.e., near side in the finger insertion direction) to form recesses. The back plate 111, the bottom end of which is connected to the front end of the bottom plate 112, partitions the space enclosed by the bottom plate 112 and the side plates 113a and 113b into a front space and a back space.

The recessed spaces formed at the back of the back plate 111 are the X-direction movement stage storage part 114 and the Y-direction movement stage storage part 115 (see FIG. 2).

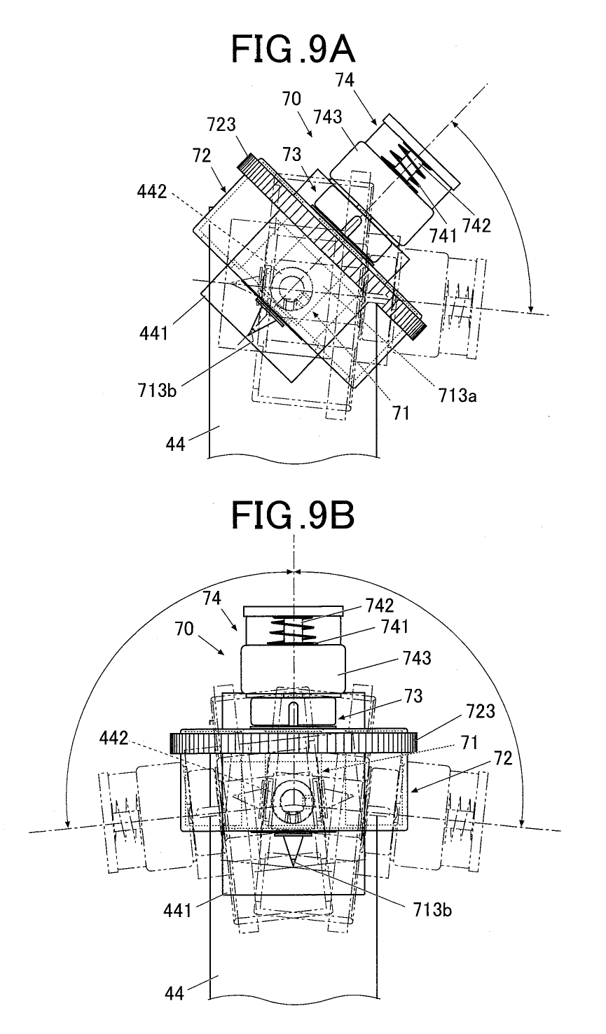

An X-direction movement stage 45 of a drawing unit 40 (see FIG. 9) fits in the X-direction movement stage storage part 114 when the drawing unit 40 moves forward (i.e., to the near side in the finger insertion direction).

A Y-direction movement stage 47 of the drawing unit 40 is disposed in the Y-direction movement stage storage part 115.

The dividing wall 116 is disposed in the lower machine casing 11 so as to vertically partition the front space inside the lower machine casing 11 (i.e., the space on the near side in the finger insertion direction enclosed by the back plate 111, the bottom plate 112 and the side plates 113a and 113b).

The dividing wall 116 lies substantially horizontally so that the left and right ends of the dividing wall 116 are connected to the side plates 113a and 113b, respectively, and so that the rear end of the dividing wall 116 is connected to the back plate 111.

The lower machine casing 11 is provided with a finger fixation section 30 integrally.

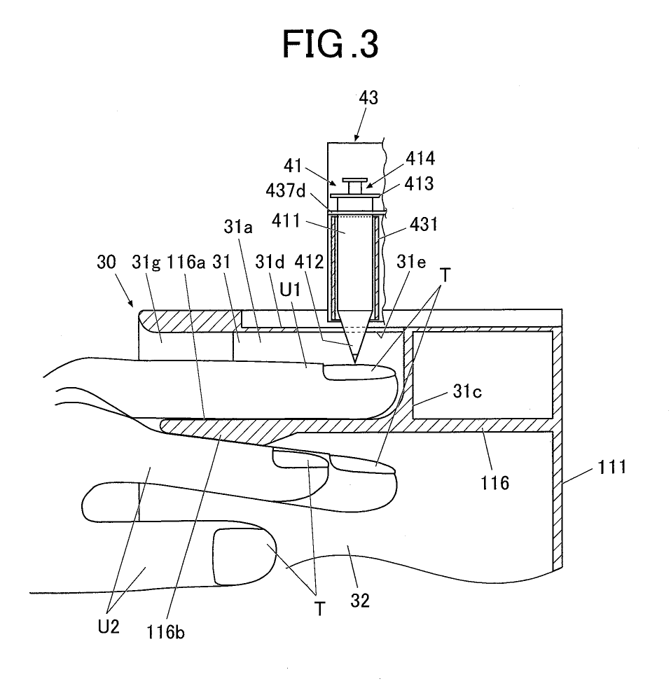

The finger fixation section 30 will now be described with reference to FIG. 3.

FIG. 3 is a sectional view, seen from the direction of the arrows, along the line of FIG. 1.

The finger fixation section 30 is constituted of a finger receiving section 31 and a finger escape section 32. The finger receiving section 31 is a section to receive a finger U1 with a nail T on which a drawing is to be made (“printing finger U1”, hereinbelow), and the finger escape section 32 is a section where fingers U2 other than the printing finger U1 (“non-printing fingers U2”, hereinbelow) are inserted.

The finger receiving section 31 is disposed over the dividing wall 116 and almost at the center of the lower machine casing 11 in the width direction.

The lower space, formed by the dividing wall 116, of the lower machine casing 11 constitutes the finger escape section 32.

For example, when a drawing is to be made on the nail T of a ring finger as shown in FIG. 3, the ring finger as a printing finger U1 is inserted in the finger receiving section 31, while the other four fingers (i.e., the thumb and index, middle, and little fingers) as non-printing fingers U2 are inserted in the finger escape section 32.

The finger receiving section 31 opens toward the front side (i.e., near side in the printing finger insertion direction) of the lower machine casing 11 and is defined by a finger placement section 116a at the bottom which constitutes a part of the dividing wall 116, partitions 31a at the both sides, and a partition 31c at the back.

The finger placement section 116a allows a finger (printing finger U1) with a drawing target nail T to be placed on an X-Y plane.

The finger receiving section 31 is defined by a ceiling 31d at the top.

The ceiling 31d has a window 31e through which the nail T of a printing finger U1 inserted in the finger receiving section 31 is exposed.

A front wall 31f which covers the front both-side parts of the lower machine casing 11 stands upright on the upper surface of the dividing wall 116 (see FIG. 1).

A pair of guide walls 31g to guide a printing finger U1 into the finger receiving section 31 stands upright on the upper surface of the dividing wall 116. The guide walls 31g narrow from the end near the center of the front wall 31f toward the finger receiving section 31.

The dividing wall 116 can be held between a printing finger U1 inserted in the finger receiving section 31 and non-printing fingers U2 inserted in the finger escape section 32 by a user. Thus, a printing finger U1 inserted in the finger receiving section 31 can be stably fixed.

In this embodiment, the dividing wall 116 is provided with a bulge 116b bulging downward at the front end portion of the dividing wall 116. The bulge 116b may form a taper portion whose thickness gradually decreases toward the near side and gradually increases toward the back. Alternatively, the entire thickness of the bulge 116b may be larger than that of the back part of the dividing wall 116.

Providing the bulge 116b at the front end portion of the dividing wall 116 creates an interspace between nails T of non-printing fingers U2 and the dividing wall 116 when the non-printing fingers U2 after drawing are inserted in the finger escape section 32, as shown in FIG. 3. This can prevent the nails T from coming into contact with the bottom surface of the dividing wall 116 and thus prevent ink from adhering to the apparatus. The designs drawn on the nails T are also prevented from being rubbed or spoiled.

As shown in FIGS. 1 and 2, a pen warm-up section 61 for warm-up of a pen 41 (described later) is provided on the upper surface of the dividing wall 116 beside the finger receiving section 31 (i.e., at the position corresponding to the medium insertion/output opening 24 of the case body 2, which is on the left side in FIG. 1 in this embodiment). The pen warm-up section 61 is provided within the region over which the drawing head 42 (described later) is movable.

Preferably, the pen warm-up section 61 is substantially the same level as the nail T of a printing finger U1 inserted in the finger receiving section 31.

The pen warm-up section 61 is a flat part on which a drawing medium (not shown) inserted through the medium insertion/output opening 24 of the case body 2 is placed.

Anything that enables warm-up (breaking-in) of a pen tip 412 may be used as a drawing medium to be placed on the pen warm-up section 61. For example, a slip of paper may be used.

The pen warm-up section 61 is used for warm-up drawing to bring a pen tip 412 in good condition before the start of image drawing based on image data on a nail T. Specifically, in the warm-up drawing, a pen 41 is carried down to a drawing medium to draw predetermined figures, such as “∘” and “∞”. This prevents fuzzy lines at the beginning of the drawing due to drying of the pen tip 412 or a bad spread of ink.

The predetermined figure to be drawn for the warm-up drawing is not particularly limited, but preferably is a simple figure such as “∘” and “∞” so as not to waste ink.

The figure, such as “∘” and “∞”, is preferably drawn at a position shifted a little each time of the warm-up drawing within the range of the pen warm-up section 61.

When almost the entire drawing medium is filled with the drawn figures, the display unit 26 displays on the screen a message demanding replacement of a drawing medium, such as “replace paper”. A user then takes the drawing medium out through the medium insertion/output opening 24 to replace it with a new one to allow warm-up drawing on the new drawing medium.

The drawing medium may be a roll of paper, for example. In this case, when there is no more space for drawing, the drawing medium of the roll paper is pulled out and warm-up drawing can be made on a new surface.

In this embodiment, a pen cap 62 made of rubber, for example, is disposed in front of the pen warm-up section 61 (i.e., at the near side in the finger insertion direction).

The number of the pen caps 62 is the same as the number of pens 41 held by the drawing unit 40. In this embodiment, the number is one. When a pen 41 loaded and held by the drawing unit 40 does not perform drawing (non-drawing time), the pen tip 412 of the pen 41 is fitted in the pen cap 62.

The area of the pen cap 62 is the home space (standby position) of the pen 41 at the non-drawing time.

Specifically, at the non-drawing time, the pen 41 is moved to the position just above the pen cap 62, is carried down with a solenoid 440 (see FIG. 5, described later), and the pen tip 412 is fitted in the pen cap 62.

Fitting the pen tip 412 in the pen cap 62 in this way prevents the pen tip 412 from drying at the non-drawing time.

The pen cap 62 is not limited to the one to receive the pen tip 412 of one pen 41. Alternatively, for example, the pen cap 62 may have the shape of groove to receive the pen tips 412 of multiple pens 41 held by the drawing unit 40.

In this embodiment, the pen cap 62 is disposed beside the pen warm-up section 61 as described above. In starting the drawing, the pen 41 is lifted and perform warm-up drawing on the close-by pen warm-up section 61, and then, regular drawing starts. This minimizes the time required for the movement of the pen 41 and enables quick drawing.

The drawing unit 40 includes the drawing head 42 including a pen (drawing tool) 41 for drawing, a unit support member 44 to support the drawing head 42, the X-direction movement stage 45 to move the drawing head 42 in the X direction (i.e., the X direction in FIG. 1 or the right-left direction of the drawing apparatus 1), an X-direction movement motor 46, the Y-direction movement stage 47 to move the drawing head 42 in the Y direction (i.e., the Y direction in FIG. 2 or the front-back direction of the drawing apparatus 1), and a Y-direction movement motor 48.

In this embodiment, the drawing head 42 has one carriage 43 to hold the pen 41.

The pen 41 is a drawing tool to make a drawing on the surface of a nail T when the tip of the pen 41 touches the surface.

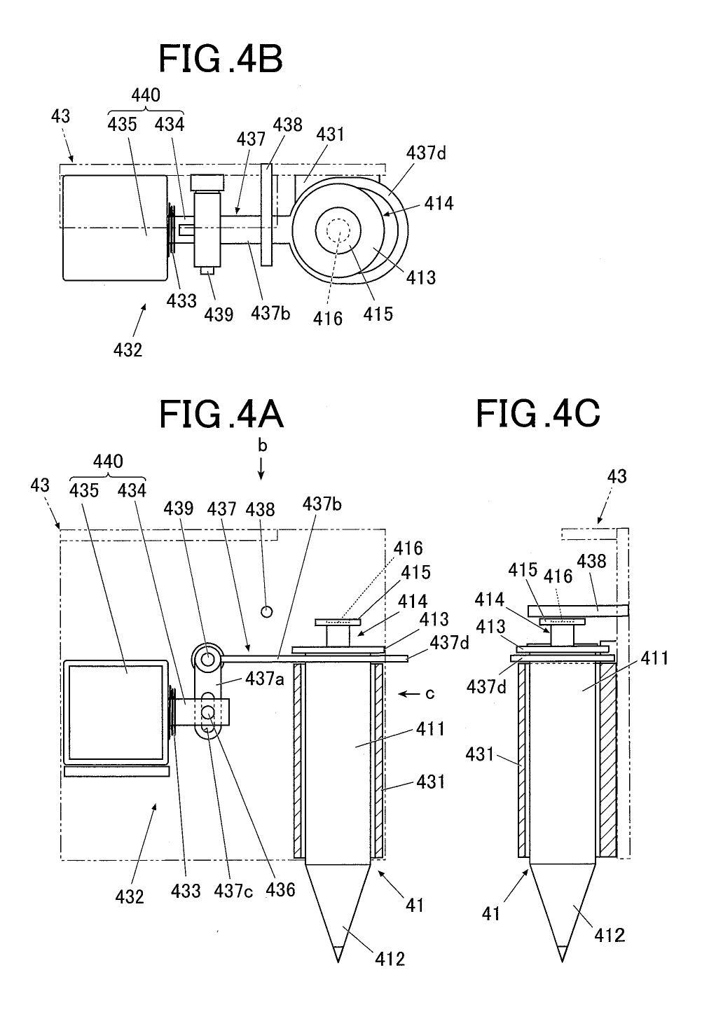

FIGS. 4A to 4C are enlarged views of a carriage 43 and a pen 41 held by the carriage 43 in the state in which drawing is performed (i.e., a drawing state).

FIG. 4A is a side view of the carriage 43 and pen 41.

FIG. 4B is a top view obtained by viewing the carriage 43 and pen 41 of FIG. 4A from the arrow b.

FIG. 4C is a front view obtained by viewing the carriage 43 and pen 41 of FIG. 4A from the arrow c.

As shown in FIGS. 4A to 4C, the pen 41 held by the carriage 43 has a pen shaft 411 and a pen tip 412 disposed at an end of the pen shaft 411.

The tip of the pen shaft 411 opposite to the pen tip 412 is referred to as “the upper part of the pen 41”, and the pen tip 412 is referred to as “the lower part of the pen 41”.

The interior of the pen shaft 411 serves as an ink container (fluid material container) to contain various types of fluid inks.

The pen shaft 411 may contain a spherical object (ball), which is not shown, with the ink to stir the ink in the pen shaft 411.

The viscosity and particle size (or particle diameter) of coloring material (e.g., pigment) of the ink (fluid material) contained in the pen shaft 411 are not particularly limited. For example, ink containing gold and silver glitter, white ink, IN-curable ink, material for gel nails, undercoats, topcoats, and nail polish may be used as the ink.

Typical ink-jet printing apparatuses use ink containing dye with a particle size of about 50 nm or less, or a pigment (coloring material) with a particle size of about 100 nm or less.

By contrast, the ink contained in the pen 41 of this embodiment contains a pigment etc. (or coloring material) having a larger particle size so that the color comes out well on a nail T.

For example, white ink to be applied to a nail T as a base contains white pigment (coloring material). A white pigment (e.g., titanium oxide: TiO₂) typically has a particle size of about 200 nm to 400 nm, and actually is several times as large as 200 nm to 400 nm due to secondary aggregation.

In the case of ink including glitter, the particle size of the glitter is quite large, e.g., about 100 μm to 200 μm.

The tendency of the particles in ink to settle depends on the specific gravity of the material rather than the size of particles. For example, TiO₂, which is a component of a white pigment, has a specific gravity of 4 relative to 1 of a solvent (e.g., water). In other words, the specific gravity of TiO₂ is much larger than that of solvent. This means that TiO₂ easily settles.

In this embodiment, a stirring operation to stir the ink in the pen 41 is performed just before the start of the drawing and at an appropriate timing in the middle of the drawing, in order to prevent settlement and aggregation of the particles in ink, as described later.

A lid 414 is attached to the other end of the pen shaft 411. The lid 414 is provided with a flange 413 protruding outward from the pen shaft 411.

The pen shaft 411 and the lid 414 may be made of any material, but resin is preferably used because it is suitable for mass production of the pen 41.

In this embodiment, the lid 414 is provided with a tab 415 at its upper part to be pinched with fingers or tweezers easily.

A small piece of iron 416 is embedded in or adheres to the tab 415 to be attached to a magnet.

The pen 41 has a pen tip 412 of a ballpoint-pen type, for example, which allows the ink in the pen shaft 411 to come out through the pen tip 412 pressed against the surface of a nail T for drawing.

The pen 41 is not limited to such a ballpoint-pen type, but may be a fiber-pen type which allows the ink to ooze through the felt pen tip for drawing, and a brush-pencil type which has a bundle of hair and performs drawing with the hair soaked with the ink. The pen tip 412 may have various shapes and thicknesses.

In the case in which the pen 41 held by the carriage 43 can be replaced with another pen 41 and a plurality of pens 41 are prepared, the types of the pen tips 412 of the pens 41 may be the same as or different from one another.

The pen 41 is held by a pen supporting part 437d and a pen holder 431 of the carriage 43, with the pen 41 just inserted into the pen supporting part 437d and the pen holder 431 from above, as described later. The pen 41 thus can be easily taken out from the supporting part 437d and the pen holder 431 to be replaced by opening the cover 23 for pen replacement of the case body 2 and pinching the tab 415 with fingers or tweezers or bringing a stick (not shown) with a magnet at its tip close to the tab 415 for the magnet to attract the iron piece 416 to pull the pen 41 up.

A user thus can replace the pen 41 held by the carriage 43 with another pen 41 having different type of pen tip 412 and ink as appropriate in accordance with a nail design to be drawn, achieving a wide variety of nail designs.

The carriage 43 includes the pen holder 431 to hold a pen 41 substantially vertically, and a pen up-and-down mechanism 432 to carry the pen 41 up and down.

The pen holder 431 is a cylindrical portion into which the pen tip 412 and the pen shaft 411 are inserted to hold the pen 41.

The pen up-and-down mechanism 432 includes a solenoid 440 including a plunger 434 and a coil 435, a pin 436 attached to the moving end part of the plunger 434 of the solenoid 440, a pen up-and-down lever 437 connected to the plunger 434 through the pin 436, and a stopper 438 to prevent the pen up-and-down lever 437 from moving up to a position exceeding the upper limit.

The plunger 434 moves back and forth like a piston in the coil 435 (wound copper wire) in the solenoid 440.

The plunger 434 is biased forward by a spring 433 (i.e., rightward in FIGS. 2 and 4A), and the solenoid 440 is a pull solenoid to pull the plunger 434 rearward (i.e., leftward in FIGS. 2 and 4A) against the biasing force of the spring 433 when the solenoid 440 is driven.

The solenoid 440 may be a push solenoid instead of the pull solenoid.

As shown in FIG. 4A, the pen up-and-down lever 437 is an L-shaped member having a short arm 437a and a long arm 437b substantially perpendicular to each other. The short arm 437a has a long hole 437c at its end part. The long hole 437c is engaged with the pin 436.

The long arm 437b has a pen supporting part 437d at its end part into which a pen 41 is to be inserted.

The pen supporting part 437d is in the shape of a ring having an inner diameter larger than those of the pen shaft 411 and pen tip 412 of the pen 41, and smaller than that of the flange 413 of the pen 41. The pen shaft 411 and pen tip 412 are inserted into the pen supporting part 437d, and the pen supporting part 437d catches the flange 413 so as to support the flange 413 from below.

The rotation shaft 439 is inserted in the intersection of the short arm 437a and the long arm 437b of the pen up-and-down lever 437, the rotation shaft 439 being fixed at the carriage 43 side.

In this embodiment, when the solenoid 440 is being driven, the plunger 434 is pulled rearward against the biasing force of the spring 433 as shown in FIG. 4A. At this time, the pen up-and-down lever 437 engaged with the pin 436 of the plunger 434 is kept in such a way that the long arm 437b is almost horizontally positioned.

In this state, the tip 412 of the pen 41 is below the pen holder 431 of the carriage 43 and can touch the surface of a nail T or a drawing medium, which is a drawing state.

When the solenoid 440 is off, the biasing force of the spring 433 pushes the plunger 434 forward.

At this time, the pen up-and-down lever 437 engaged with the pin 436 of the plunger 434 rotates upward (i.e., in the counterclockwise direction) with the rotation shaft 439 as a pivot point until the long arm 437b touches the stopper 438 and stops.

In this way, the pen up-and-down lever 437 brings the flange 413 of the pen 41 upward (see FIG. 2).

In this state, the tip 412 of the pen 41 is above the pen holder 431 of the carriage 43 and does not touch the surface of a nail T or a drawing medium, which is a non-drawing state.

In this way, the force to move the plunger 434 back and forth produced by the solenoid 440 is converted to the force to move the pen 41 up and down through the rotation shaft 439 and the pen up-and-down lever 437 rotating about the rotation shaft 439.

The pen 41 is just inserted in the pen holder 431 of the carriage 43 but is not fixed to the pen up-and-down lever 437 etc. This allows the pen 41 to be biased downward for its own weight.

The pen 41 thus can freely go down the pen holder 431 until the flange 413 comes into contact with the upper surface of the pen supporting part 437d, and when the pen tip 412 touches the surface of a nail T or a drawing medium, the pen tip 412 presses the surface of the nail T or the drawing medium.

In other words, when the pen 41 makes a drawing on a nail T, the pen tip 412 can freely move in the Z direction (i.e., vertical direction) perpendicular to the X-Y plane, on which a printing finger U1 is placed, along the shape (ups and downs) of the surface of the nail T in accordance with the curve and height of the nail T.

For example, when a drawing is to be made on a low area of a nail T (for example, the both end parts of a nail T in the width direction), a pen 41 comes down almost to such a position as the flange 413 touches the upper surface of the pen supporting part 437d. On the other hand, when a drawing is to be made on a high area of a nail T (for example, the center part of a nail T in the width direction), a pen 41 goes up in accordance with the level of the nail T and the flange 413 goes away from the upper surface of the pen supporting part 437d.

The pen 41 is light in weight, e.g., several grams to several tens of grams, and a user does not feel a pain when the pen tip 412 touches a nail T. The weight of the pen 41, however, applies an enough pen pressure, enabling production of excellent nail designs on nails T.

In this embodiment, the rotation shaft 439 and the stopper 438 are made of metal, such as stainless-steel; and the other members constituting the pen up-and-down mechanism 432 are made of material, such as resin, which is light in weight and does not react with a magnet. The materials of the members constituting the pen up-and-down mechanism 432 are not limited to those shown above.

The solenoid 440 is used as an actuator to move the pen 41 up and down in this embodiment. The actuator to move the pen 41 up and down, however, is not limited to the solenoid 440.

Since the pen 41 is light in weight, the actuator to move the pen 41 up and down may be constituted of various types of compact driving devices, instead of the solenoid.

The drawing head 42 is supported by a head support member 441. The head support member 441 is connected to the unit support member 44 through a shaft 442.

Specifically, as shown in FIG. 2, a rotary solenoid 443 is attached to the upper part on the back side (i.e., the back side of the drawing apparatus 1 or the right side in FIG. 2) of the unit support member 44.

The lower end part of the head support member 441 is fixed to the shaft 442, which is the rotation shaft of the rotary solenoid 443.

The rotary solenoid 443 can rotate the shaft 442 about its axis forward and reversely.

Rotation of the shaft 442 of the rotary solenoid 443 enables forward and reverse rotation of the head support member 441, which is fixed to the shaft 442, with the axis of the shaft 442 as the rotation center.

The rotary solenoid 443 is an angle changing unit to change the tilt angle of the drawing head 42 by rotating the head support member 441.

Further, the rotary solenoid 443 serves as a stirring unit to perform a stirring operation to stir the ink in the pen shaft 411, which is an ink container, by tilting the drawing head 42 before the drawing head 42 performs drawing.

In this embodiment, during the stirring operation, the rotary solenoid 443 tilts the drawing head 42 at i) a first tilt angle where one end part (e.g., upper part) of the pen shaft 411 is below the level of the other end part (e.g., lower part) of the pen shaft 411, and ii) a second tilt angle where one end part (e.g., upper part) of the pen shaft 411 is above the level of the other end part (e.g., lower part) of the pen shaft 411.

Detailed explanations are given below.

In this embodiment, the drawing head 42 is substantially perpendicular to the X-Y plane in an initial state in which the rotary solenoid 443 is not being driven.

The tilt angle of the drawing head 42 in the initial state is defined as “0°”. The rotary solenoid 443 can tilt the drawing head 42 from the tilt angle “0°” to the tilt angle over “90°” from the vertical to the X-Y plane (e.g., “95°” where the drawing head 42 has been rotated more largely than to the position where the drawing head 42 is parallel to the X-Y plane, and where the upper part of the drawing head 42 is below the level of the lower part of the drawing head 42).

Specifically, when the rotary solenoid 443 is driven, the drawing head 42 tilts from the tilt angle “0°” to over “90°” (e.g., “95°”).

When the rotary solenoid 443 is off, the drawing head 42 returns from the tilt angle over “90°” to “0°”.

Such an ON/OFF operation of the rotary solenoid 443 swings the drawing head 42 between the tilt angles “0°” and “95°”, for example. The ink in the pen 41 is thus stirred.

Such a stirring operation is preferably repeated a plurality of times to fully stir the ink.

In the case in which a spherical object (ball) is contained in the pen shaft 411 in addition to the ink, the ink in the pen 41 is stirred by the movement of the spherical object in the pen 41. When the tilt angle of the drawing head 42 exceeds “90°”, the pen shaft 411 or ink container is largely inclined to a plane parallel to the X-Y plane and the upper part of the drawing head 42 is below the level of the lower part of the drawing head 42. In such a state, the spherical object moves in the ink container.

In view of this, the drawing head 42 is preferably tilted at a tilt angle over “90°” in the stirring operation by driving the rotary solenoid 443.

In FIG. 1, the state in which the drawing head 42 is substantially perpendicular to the X-Y plane is indicated by solid lines, whereas the state in which the drawing head 42 is tilted by the rotary solenoid 443 at a tilt angle of about “95°”, i.e., tilted more largely than to the position where the drawing head 42 is parallel to the X-Y plane, is indicated by two-dot chain lines.

The tilt angle of the drawing head 42 is not limited to the example shown above but may be set to other angles as long as driving the rotary solenoid 443 allows the pen shaft 411 or ink container of the pen 41 to tilt more largely than “90°” where the pen shaft 411 is parallel to the X-Y plane. Specifically, the tilt angle may be still larger, such as “100°”.

If the stirring operation is performed a plurality of times, the drawing head 42 does not have to be returned to the initial state (i.e., the tilt angle: “0°”) after the drawing head 42 is tilted at an angle greater than “90°”. For example, the drawing head 42 may swing a plurality of times between the tilt angles “95°” and “47.5°”, or between the tilt angles “100°” and “50°”.

The drawing head 42 may swing from side to side largely as long as the swinging drawing head 42 does not interfere with other components in the apparatus. Specifically, for example, the drawing head 42 may swing from side to side between the tilt angles “95°” (right) and “−95°” (left), with the tilt angle “0°” as the center.

Further alternatively, the tilt angle may be adjusted in a stepless manner, instead of swinging the drawing head 42 between predetermined two tilt angles, such as “0°” and “95°”.

In this embodiment, the rotary solenoid 443 as an angle changing unit can further adjust the tilt angle of the drawing head 42 to the surface of a nail T in the width direction when the pen 41 performs drawing on the nail T.

Specifically, the rotary solenoid 443 adjusts the tilt angle of the drawing head 42 (or the pen 41 held by the drawing head 42) to the X-Y plane in accordance with the inclination angle of the surface of a nail T (i.e., the angle to the X-Y plane on which the nail T is placed) detected by the nail information detector 812 (see FIG. 5, described later).

More specifically, when the drawing head 42 performs drawing on the area of both end parts of the surface of a nail T in the width direction, the rotary solenoid 443 adjusts the tilt angle of the drawing head 42 so that the angle of the drawing head 42 to the nail surface in the width direction is close to the angle of the drawing head 42 to the nail surface at a time when the drawing head 42 performs drawing on the center part of the nail surface in the width direction.

The pen 41 used in the drawing apparatus 1 can draw lines etc. most stably when the pen tip 412 touches the surface of a nail T or drawing target substantially vertically.

A nail T has a curved shape with the height getting lower from its center part toward the edges in the width direction. The inclination of the nail T is larger as a position gets closer to the both-side edges in the width direction.

If the drawing head 42 performs drawing while the tilt angle of the drawing head 42 is “0°” (i.e., while the drawing head 42 is substantially perpendicular to the X-Y plane), the pen 41 touches the surface of the nail T substantially vertically in the center part in the width direction, whereas the pen 41 touches the surface of the nail T diagonally in the both end parts of the nail T in the width direction. For this reason, drawing might be impossible or a line thickness might change on the both end parts of the nail T in the width direction depending on the inclination angle or depending on the type of the pen tip 412. This may fail to achieve high-definition drawings.

By contrast, in the present embodiment, the drawing head 42 is tilted when performing drawing on the both end parts of the surface of a nail T in the width direction, so that the angle of the drawing head 42 to the both end parts of the nail surface in the width direction is close to the angle of the drawing head 42 to the nail surface at a time of performing drawing on the center part of the nail surface in the width direction (i.e., almost right angle).

This enables high-definition drawing on the both end parts of a nail T by making the conditions for drawing on the both end parts close to those for drawing on the center part of the nail T.

The mechanism constituting the angle changing unit to adjust the tilt angle, to the X-Y plane, of the drawing head 42 (or the pen 41 held by the drawing head 42) is not limited to the rotary solenoid 443.

The angle changing unit may be constituted of various motors, such as a step motor or servomotor.

The rotary solenoid 443 may change the tilt angle in a few steps, such as two steps of “0°” and “95°” or three steps of “0°”, “47.5°”, and “95°”. Alternatively, the rotary solenoid 443 may make finer adjustment of the tilt angle for rotating the shaft 442.

For example, a rotary solenoid 443 that can control the tilt angle in an almost stepless manner, or a step motor or servomotor maybe used as the angle changing unit to rotate the shaft 442 in an almost stepless manner.

The unit support member 44 supporting the drawing head 42 is fixed to an X-direction movement section 451 attached to the X-direction movement stage 45.

The X-direction movement motor 46 drives the X-direction movement section 451 to move in the X direction along a guide (not shown) on the X-direction movement stage 45. This allows the drawing head 42 to move in the X direction (i.e., the X direction in FIG. 1 or the right-left direction of the drawing apparatus 1).

The X-direction movement stage 45 is fixed to the Y-direction movement section 471 of the Y-direction movement stage 47.

The Y-direction movement motor 48 drives the Y-direction movement section 471 to move in the Y direction along a guide (not shown) on the Y-direction movement stage 47. This allows the drawing head 42 to move in the Y direction (i.e., the Y direction in FIG. 2 or the front-back direction of the drawing apparatus 1).

In this embodiment, the X-direction movement stage 45 and the Y-direction movement stage 47 are constituted of the combination of the X-direction movement motor 46, the Y-direction movement motor 48, ball screws (not shown), and guides (not shown).

The X-direction movement motor 46 and the Y-direction movement motor 48 in this embodiment are step motors which make a predetermined amount of movement for each pulse.

In this embodiment, the X-direction movement motor 46, the Y-direction movement motor 48 and the like constitute a head drive section 49 (see FIG. 5) to move the drawing head 42 including the pen 41 for drawing on a nail T in the X and Y directions.

As shown in FIGS. 1 and 2, the photographing unit 50 is disposed on the upper machine casing 12.

A substrate 13 is disposed on the upper machine casing 12, and two cameras 51 as photographing devices are disposed at the center of the lower surface of the substrate 13. The cameras 51 preferably have about two million pixels or more.

The cameras 51 photograph the nail T of a printing finger U1 inserted in the finger receiving section 31 to obtain nail images (i.e., finger images each including the image of the nail T), which are the images of the nail T of the printing finger U1.

In this embodiment, the two cameras 51 are arranged substantially side by side in the width direction of the nail T of a printing finger U1 inserted in the finger receiving section 31.

One of the two cameras 51 faces the bottom face of the finger receiving section 31 to photograph a nail T from just above.

The other of the two cameras 51 is slightly tilted to the bottom face of the finger receiving section 31 to photograph the nail T from diagonally above.

The substrate 13 is provided with illuminators (illuminating devices) 52, such as white LEDs, disposed in such a way as to surround the cameras 51.

The illuminators 52 illuminate the nail T of a printing finger U1 at the time of the photographing by the cameras 51. The photographing unit 50 is constituted of the cameras 51 and the illuminators 52.

The photographing unit 50 is connected to a photographing controller 811 of a control device 80 (see FIG. 5, described later) to be controlled by the photographing controller 811.

The image data of images obtained by the photographing unit 50 is stored in a nail image storage area 821 of a storage unit 82, described later.

In this embodiment, two cameras 51 as photographing devices photograph a nail T from at least two different positions or angles to obtain at least two nail images.

A nail information detector 812 (described later) detects nail information, such as the contour (shape) of a nail T, inclination angle of the surface of a nail T to the X-Y plane (hereinafter referred to as “inclination angle of a nail T” or “nail curvature”), and the vertical position of a nail T, on the basis of the nail images.

Taking the images of a nail T from just above and from diagonally above the nail T enables accurate detection of the position of the nail T and inclination angle of the surface of the nail T as well as the contour of the nail T.

The apparatus does not necessarily have to include two cameras 51 as photographing devices to detect the inclination angle or curvature of nails T. The apparatus may photograph a nail T only from just above the nail T just to detect the contour (shape) of the nail T as nail information.

The control device 80 is disposed on the substrate 13 on the upper machine casing 12, for example.

FIG. 5 is a block diagram showing the principal control configuration in this embodiment.

As shown in FIG. 5, the control device 80 is a computer including a control unit 81 constituted of a central processing unit (CPU), and a storage unit 82 constituted of a read only memory (ROM) and a random access memory (RAM), for example (the CPU, ROM and RAM are not shown).

The storage unit 82 contains various programs and various pieces of data for the operation of the drawing apparatus 1.

Specifically, the ROM of the storage unit 82 contains various programs, such as a nail information detection program to detect nail information, such as the shape and inclination angle of a nail T, from nail images; a drawing data generation program to generate drawing data based on the image data of nail designs to perform drawing on nails T; and a drawing program to perform drawing processing. Each unit of the drawing apparatus 1 is comprehensively controlled through the execution of these programs by the control device 80.

In this embodiment, the storage unit 82 includes a nail image storage area 821, a nail information storage area 822, and a nail design storage area 823. The nail image storage area 821 stores nail images of the nail T of a user' s printing finger U1 obtained by the photographing unit 50. The nail information storage area 822 stores the nail information (including the contours and inclination angles of nails T) detected by the nail information detector 812. The nail design storage area 823 stores the image data of nail designs to be drawn on nails T.

The control unit 81 includes the photographing controller 811, the nail information detector 812, the drawing data generator 813, the display controller 814, and the drawing controller 815, in terms of its function.

The functions as the photographing controller 811, the nail information detector 812, the drawing data generator 813, the display controller 814, and the drawing controller 815 are carried out through cooperation between the CPU of the control unit 81 and the programs stored in the ROM of the storage unit 82.

The photographing controller 811 controls the cameras 51 and the illuminators 52 of the photographing unit 50 so that the cameras 51 take finger images each including the image of the nail T of a printing finger U1 inserted in the finger receiving section 31 (hereinafter referred to as “nail images”).

In this embodiment, the photographing controller 811 allows the two cameras 51 to obtain at least two nail images from different positions or angles (e.g., from just above a nail T and diagonally above the nail T).

The image data of nail images obtained by the photographing unit 50 may be stored in the storage unit 82.

The nail information detector 812 detects the nail information on the nail T of a printing finger U1 on the basis of the images of the nail T of the printing finger U1 inserted in the finger receiving section 31 obtained by the cameras 51.

In this embodiment, the nail information detector 812 detects the inclination angles of nails T.

The nail information includes the information on the contour of a nail T (i.e., the shape or the horizontal position of a nail T), the height of a nail T (i.e., the position of a nail T in the vertical direction, hereinafter referred to as “vertical position of a nail T” or simply as “the position of a nail T”), and the inclination angle of the surface of a nail T to the X-Y plane (i.e., the inclination angle of a nail T or nail curvature).

The inclination angle of a nail T (or nail curvature) refers to the angle to the horizontal plane in the width direction of the nail T (i.e., to the X-Y plane of the finger placement section 116a on which the printing finger U1 is placed). In this embodiment, the nail information detector 812 detects the contour (shape or horizontal position) of the nail T and the inclination angle of the nail T (nail curvature) based on nail images.

Specifically, the nail information detector 812 detects the contour (shape and size) and position of the nail T from the nail images of the nail T of a printing finger U1 obtained by the cameras 51. Thus, the contour is acquired as the information represented by x-y coordinates, for example.

For example, the nail information detector 812 detects the contour (shape) of a nail T on the basis of the difference in color between the nail T and the other part of the finger, from the nail images of the nail T of the printing finger U1 obtained by the cameras 51.

The method to detect the contour (shape) of a nail T is not limited to the example shown here, but the nail information detector 812 may use any other method.

The nail information detector 812 detects the inclination angle of a nail T (nail curvature) on the basis of at least two nail images obtained by the two cameras 51.

The nail information detector 812 detects the position and inclination angle (curvature) of a user' s nail Ton the basis of the difference in position and shape appearing in the two nail images taken by the two cameras 51 from different positions or angles (e.g., from just above and diagonally above the nail T).

The method to detect the inclination angle of a nail T (nail curvature) is not limited to the example shown here, but the nail information detector 812 may use any other method.

The drawing data generator 813 generates drawing data to be applied to the nail T of a printing finger U1 by the drawing head 42 on the basis of the nail information detected by the nail information detector 812.

Specifically, the drawing data generator 813 performs a fitting process such as expansion or reduction in size or clipping of the image data of a nail design on the basis of the shape of a nail T detected by the nail information detector 812.

In this embodiment, the drawing data generator 813 performs curved surface correction on the image data of a nail design in accordance with the inclination angle of a nail T (nail curvature) detected by the nail information detector 812.

The drawing data to be applied to the nail T is thus generated.

The display controller 814 controls the display unit 26 to display various screens on the display unit 26.

In this embodiment, the display controller 814 controls the display unit 26 to display a selection screen to allow selection of a nail design, a thumbnail image for confirmation of a design, nail images obtained by the photographing of a printing finger U1, and various instruction screens.

The drawing controller 815 outputs drawing data generated by the drawing data generator 813 to the drawing unit 40 and controls the drawing unit 40, the solenoid 440, the rotary solenoid 443, the X-direction movement motor 46, and the Y-direction movement motor 48 to make a drawing based on the drawing data on a nail T.

In this embodiment, the drawing controller 815 operates the rotary solenoid 443 just before the start of the drawing operation by the drawing head 42, to perform a stirring operation to stir the ink in the pen shaft 411 (or ink container) of the pen 41.

Specifically, for example, the drawing controller 815 switches ON/OFF of the rotary solenoid 443 to greatly tilt the drawing head 42 from the initial state in which the tilt angle of the pen 41 is “0°” to the state in which the tilt angle is “95°”, one or more times.

The speed at which the drawing head 42 is tilted from the initial state (tilt angle: “0°”) is not particularly limited. If the tilt angle is large enough, the spherical object in the pen shaft 411 can move and the ink can be stirred even if the tilting speed is slow.

The number of repeats of the stirring operation is not particularly limited. The number of repeats of the stirring operation is set in advance in accordance with, for example, the type of ink. The number of repeats of the stirring operation for different types of inks may be set to different numbers.

The stirring operation is performed after the pen 41 is pulled from the pen cap 62 and before the pen 41 has moved to a drawing position (i.e., a position above the surface of a nail T), for example.

The position at which the stirring operation is performed is not limited to this. The stirring operation may be performed at any position where the drawing head 42 and the pen 41 do not interfere with surrounding components in the apparatus.

The stirring operation may also be performed in the middle of the drawing as appropriate.

In such a case, the stirring operation may be performed above the drawing position at which the drawing on a nail T is performed. The stirring operation is, however, preferably performed at the home space where the pen cap 62 etc. is disposed.

The stirring operation performed in the middle of the drawing may be the same operation as the stirring operation performed before the start of the drawing. Alternatively, stirring operation performed in the middle of the drawing may be different from the stirring operation performed before the start of the drawing. For example, the number of stirs in the stirring operation in the middle of the drawing may be smaller than that in the stirring operation before the start of the drawing. The tilt angle of the drawing head 42 in the stirring operation in the middle of the drawing may be smaller than that in the stirring operation before the start of the drawing.

When the drawing is performed on a nail T with the pen 41, the drawing controller 815 in this embodiment controls the rotary solenoid 443 to adjust the tilt angle of the drawing head 42, holding the pen 41, to the X-Y plane in accordance with the inclination angle of the surface of the nail T detected by the nail information detector 812.

In performing such drawing, the touching position of the pen tip 412 to the nail T varies when the tilt angle of the drawing head 42 (or the pen 41 held by the drawing head 42) is adjusted.

The drawing controller 815 corrects the drawing position in accordance with the variation in the touching position of the pen tip 412.

The operation for the drawing with the drawing apparatus 1 in this embodiment will now be described.

In performing drawing with the drawing apparatus 1, a user first operates the electrical power switch button of the operation unit 25 to start the control device 80.

The display controller 814 controls the display unit 26 to display the design selection screen.

The user operates the design selection button of the operation unit 25 and selects a desired nail design among a plurality of nail designs displayed on the design selection screen.

This causes the operation unit 25 to output a selection instruction signal so that a nail design to be drawn on a nail T is selected

Upon selection of a nail design, the control unit 81 allows the display unit 26 to display an instruction screen urging a user to load a pen(s) 41 required for drawing the selected nail design onto the carriage 43 of the drawing head 42.

When red ink and ink containing gold glitter are needed, for example, the control unit 81 gives instructions through the display unit 26 about which pens 41 are to be loaded onto the carriage 43.

A user loads a predetermined type of pen 41 onto the carriage 43 in accordance with the instructions displayed on the screen.

Alternatively, a user may dare to load a pen 41 different from the instructions to create a nail design with desired color and texture.

The information on which pen 41 is held by the carriage 43 may be read by the control unit 81 using a bar code, for example. In this case, nail designs which can be created with the pen 41 held by the carriage 43 may be displayed on the design selection screen of the display unit 26 so that a user can select one of the nail designs.

Next, the user inserts a printing finger U1 in the finger receiving section 31 and inserts non-printing fingers 112 in the finger escape section 32 so as to fix the printing finger U1. The user then operates a drawing switch button in this state.

In FIG. 3, for example, the left ring finger is inserted in the finger receiving section 31 as a printing finger U1, and the other fingers are inserted in the finger escape section 32 as non-printing fingers U2.

Before the start of a drawing operation, the photographing controller 811 controls the photographing unit 50 so that the two cameras 51 photograph the printing finger U1 while the illuminators 52 illuminate the printing finger U1 in response to an instruction input from the drawing switch button.

The photographing controller 811 thus obtains at least two images (nail images) of the nail T of the printing finger U1 inserted in the finger receiving section 31.

Next, the nail information detector 812 detects the contour (shape) of the nail T on the basis of the nail images.

The nail information detector 812 detects the inclination angle (curvature) and position of the nail T on the basis of the nail images.

After the nail information detector 812 detects the contour (shape) and inclination angle (curvature) of the nail T, the drawing data generator 813 performs the fitting process to fit the image data of the nail design to the nail T on the basis of the nail information.

The drawing data generator 813 then performs the curved surface correction on the image data of the nail design on the basis of the nail information. Thus, drawing data is generated.

Next, the drawing controller 815 operates the rotary solenoid 443 to rotate the shaft 442 about its axis to tilt (swing) the drawing head 42 from the tilt angle “0°” to the tilt angle “95°” one or more times.

This operation stirs the ink in the pen shaft 411 or ink container.

Before the start of drawing on the nail T, the drawing controller 815 moves the drawing unit 40 to the position above the pen warm-up section 61, and drives the solenoid 440 of the carriage 43 holding a pen 41 so that the pen 41 is ready for drawing.

The warm-up drawing is then performed on a drawing medium by drawing predetermined figures such as “∘” and “∞”.

The warm-up drawing may be performed by only the pens 41 required to draw a selected nail design or alternatively may be performed by all the pens 41.

After the completion of the ink stirring operation and the completion of the warm-up drawing, the drawing controller 815 outputs the drawing data to the drawing unit 40 and allows the drawing head 42 to perform drawing based on the drawing data.

In performing drawing, the drawing controller 815 controls the operation of the rotary solenoid 443 to adjust the tilt angle of the drawing head 42 (or the pen 41 held by the drawing head 42) to the X-Y plane in accordance with the inclination angle of the surface of the nail T.

The drawing operation may be interrupted in mid-course for the stirring operation to be performed as appropriate when there is a risk of settlement and aggregation in ink in the middle of the drawing, such as the case in which an ink prone to cause settlement (e.g., pigment) is used for the drawing or the case in which the drawing lasts for a long time.

For example, if a plurality of design parts (small design marks or stripe pattern) are to be drawn on a base ink applied to a nail T, the stirring operation may be performed when the application of the base is completed and/or each time the drawing of a design part is completed.

The drawing operation may be interrupted for the stirring operation to be performed each time a predetermined time has elapsed since the start of the drawing.

For performing drawing on the nails T of a plurality of fingers, a finger with the nail T for which drawing has completed is pulled out of the finger receiving section 31 and a finger with a next drawing target nail T is inserted in the finger receiving section 31 as a printing finger U1. The nail images of the nail T are then obtained. These processes are then repeated.

Before the start of the drawing on the nail T of the next printing finger U1, the drawing controller 815 preferably operates the rotary solenoid 443 to perform the ink stirring operation again.

When a pen 41 is to be replaced, the drawing controller 815 moves the drawing head 42 to the position corresponding to the cover 23 for pen replacement.

A user can open the cover 23 for pen replacement at this time to take out and replace a pen 41.

As described above, the drawing apparatus 1 of this embodiment includes the rotary solenoid 443 as an angle changing unit to adjust the tilt angle of the drawing head 42. Before the drawing by the drawing head 42, the drawing apparatus 1 operates the rotary solenoid 443 to perform the stirring operation in which the drawing head 42 is tilted and the ink in the pen shaft 411 or ink container is stirred.

Such a configuration prevents clogging of ink due to the settlement and aggregation of the pigment contained in the ink in the ink container before the drawing even if the pigment has a large particle size or large specific gravity. This achieves high-definition drawings having intended colors.

The rotary solenoid 443 or angle changing unit of this embodiment can adjust the tilt angle of the drawing head 42 to the surface of a nail T in the width direction.

This configuration can greatly move the pen shaft 411 or ink container within a relatively small space and thus prevents the pen shaft 411 from interfering with surrounding components in the apparatus. This means that the stirring operation can be performed without an increase in size of the apparatus.

The rotary solenoid 443, which can adjust the tilt angle of the drawing head 42 to the surface of a nail T in the width direction, can adjust the tilt angle of the drawing head 42 (or the pen 41 held by the drawing head 42) to the X-Y plane, in accordance with the inclination angle of the surface of the nail T when the pen 41 performs drawing on the nail T.

In other words, the rotary solenoid 443, a single component, can perform both i) the adjustment of the angle of the drawing head 42 at the time of drawing according to the inclination angle of the surface of the nail T and ii) the ink stirring operation before the drawing. Such a configuration achieves a drawing apparatus 1 free from settlement and aggregation in ink and having a simple structure with reduced number of components.

In this embodiment, the drawing head is provided with a pen 41 as a drawing tool whose tip touches the surface of a nail T to perform drawing.

Such a configuration allows drawing with an opaque color, allows the use of ink containing coloring material and glitter with a large particle size, like those used for nail polish on the market, and allows the use of high-viscosity ink. The drawing apparatus 1, therefore, has more degree of freedom in types of inks to be used than an ink-jet printing apparatus, and thus can create nail designs like the ones created at nail salons.

The ink stirring operation performed before the start of the drawing prevents clogging of ink due to settlement and aggregation in ink even if such an ink is used. The drawing apparatus 1 thus can achieve high-definition drawings having intended colors.

### Second Embodiment

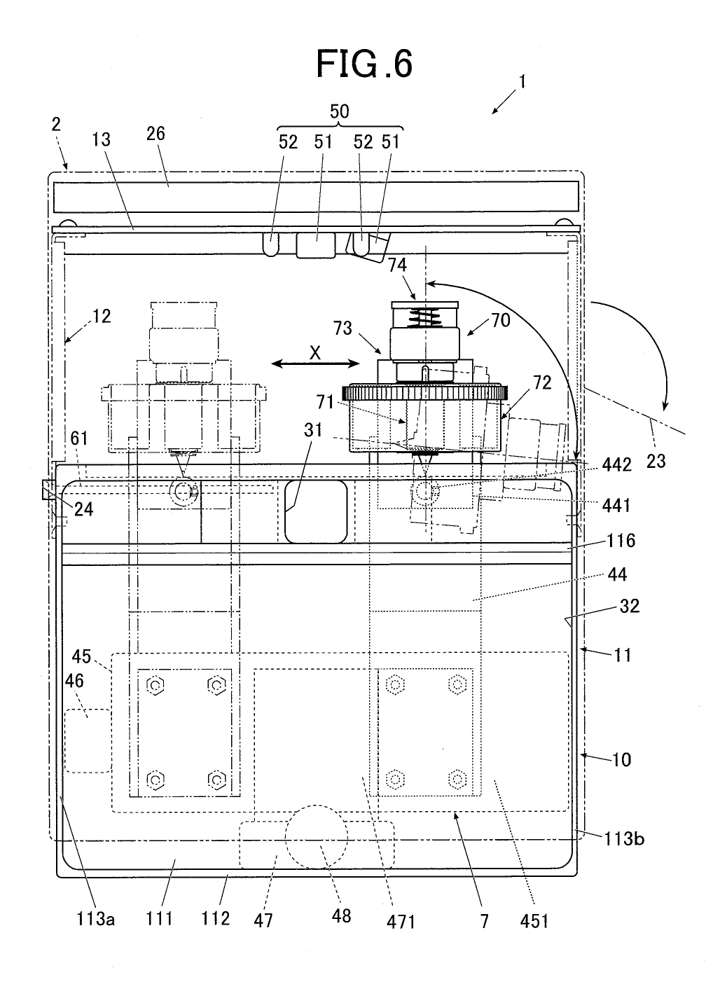

A drawing apparatus of a second embodiment of the present invention will now be described with reference to FIGS. 6 to 9.

The second embodiment is different from the first embodiment only in the configuration of a drawing unit, and the features of the second embodiment different from those of the first embodiment will be described below in particular.

FIG. 6 is a front view of a drawing apparatus in the second embodiment.

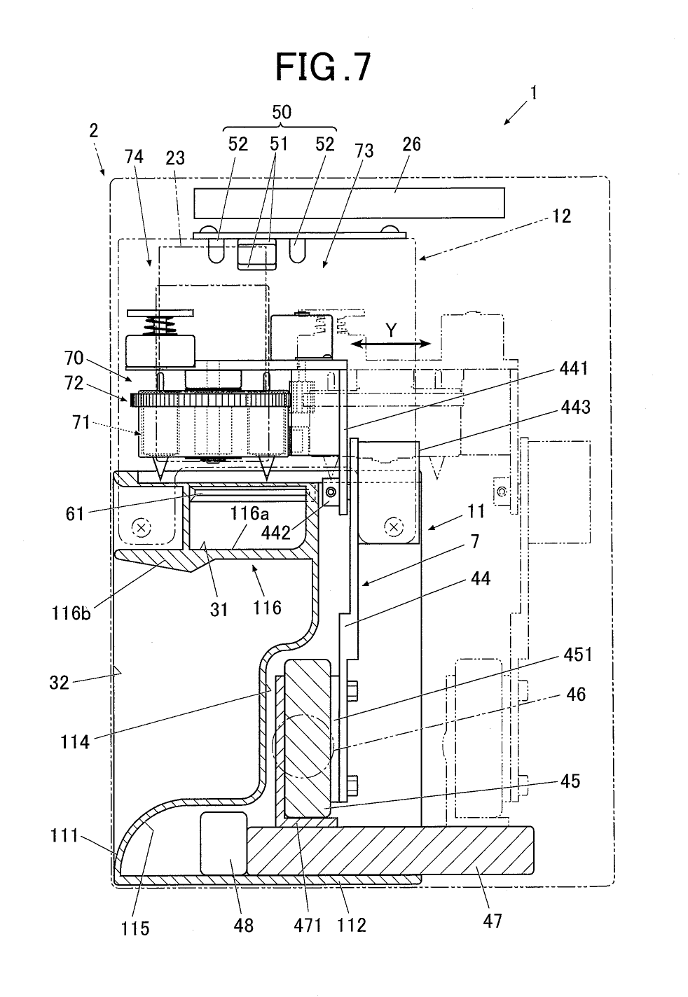

FIG. 7 is a side view of the drawing apparatus in FIG. 6 with a part thereof shown in section to show the internal structure.

As shown in FIGS. 6 and 7, a drawing unit 7 includes a drawing head 70 having pens 71 for drawing, a head support member 441 to support the drawing head 70, a unit support member 44 to which the head support member 441 is connected through a shaft 442, a rotary solenoid 443 to rotate the drawing head 70 supported by the head support member 441 about the axis of the shaft 442, an X-direction movement stage 45 to move the drawing head 70 in the X direction (i.e., the X direction in FIG. 6 or the right-left direction of the drawing apparatus 1), an X-direction movement motor 46, a Y-direction movement stage 47 to move the drawing head 70 in the Y direction (i.e., the Y direction in FIG. 6 or the front-back direction of the drawing apparatus 1), and a Y-direction movement motor 48.

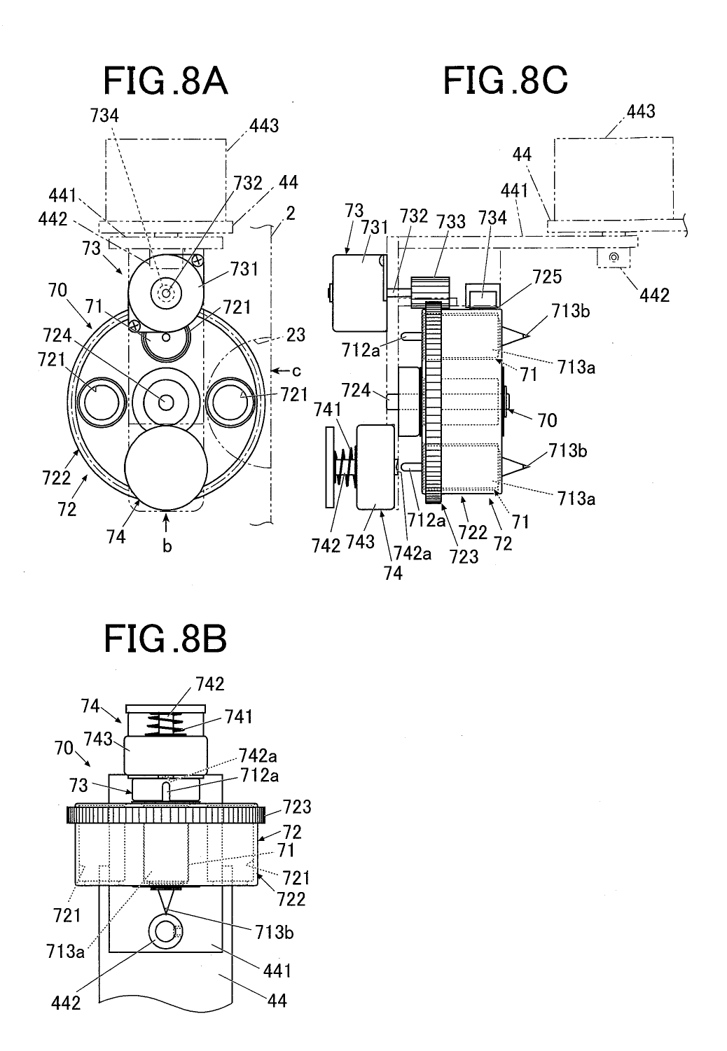

FIG. 8A is a top view of the drawing head 70.

FIG. 8B is a front view of the drawing head 70, seen from the direction of arrow b of FIG. 8A.

FIG. 8C is a side view of the drawing head 70, seen from the direction of arrow c of FIG. 8A.

As shown in FIGS. BE and 8C, each of the pens 71 of this embodiment has a pen shaft 713a with a pen tip 713b at its end (i.e., the lower end in FIG. 8B).

A shaft 712a is provided on the other end (i.e., the upper end in FIG. 8B) of each pen shaft 713a.

The interior of each pen shaft 713a serves as an ink container to contain various types of inks.

Similarly to the first embodiment, various types of inks may be used as the ink contained in the pen shafts 713a. Examples of the inks include an ink containing a pigment (coloring material) having a relatively large particle size or large specific gravity.

As shown in FIGS. 8A to 8C, the drawing head 70 of this embodiment includes a rotary carriage 72 that can hold a plurality of pens 71, a carriage rotating mechanism 73 to rotate the carriage 72, and a pen up-and-down mechanism 74 to carry a pen 71 held by the carriage 72 up and down.

The carriage 72 of this embodiment has a cylindrical carriage body 722 having four pen holders 721 along its periphery.

The number of the pen holders 721 is not particularly limited and may be more than or less than four. Increased number of pen holders 721 can hold increased number of pens 71 at one time, achieving complex nail designs with various inks.

It is not necessary that all of the pen holders 721 hold pens 71.

FIGS. 8A and 8C illustrate an example in which two of the four pen holders 721 hold pens 71.

A gear 723 is provided on the outer periphery of the carriage body 722.

The carriage 72 is provided with a rotation shaft 724 substantially in its center. The carriage 72 can rotate about the axis of the rotation shaft 724 substantially horizontally.

A reference mark 725 to indicate a reference position for the rotation of the carriage 72 is provided at a predetermined position (e.g., the position corresponding to a certain pen holder 721) on the outer periphery of the carriage body 722 of the carriage 72.

The reference mark 725, which is constituted of a reflecting cloth or a reflecting sheet to be read by an optical sensor, is fixed (e.g., pasted) to the outer periphery of the carriage body 722.

As shown in FIG. 8C, the carriage rotating mechanism 73 includes a step motor 731 and a gear 733 connected to the step motor 731 through a rotation shaft 732 and engaged with the gear 723 of the carriage body 722.

In this embodiment, when the step motor 731 is driven to rotate the rotation shaft 732 and the gear 733 attached to the rotation shaft 732, the gear 723 of the carriage body 722 engaged with the gear 733 rotates. The carriage 72 thus rotates rightward and leftward about the axis of the rotation shaft 724.

The carriage rotating mechanism 73 is provided with a mark reader 734 to read the reference mark 725 of the carriage 72.

The mark reader 734 includes an optical sensor to read the reference mark 725 constituted of, for example, a reflecting cloth or a reflecting sheet.

Each time the mark reader 734 reads the reference mark 725, the mark reader 734 outputs the result of the reading to the drawing controller 815.

The pen up-and-down mechanism 74 is constituted of a solenoid and includes a plunger 742 biased upward by a spring 741 (i.e., upward in FIG. 8B), and a coil 743 to push the plunger 742 downward against the basing force of the spring 741.

A conical hollow 742a to receive the tip of the shaft 712a of a pen 71 is formed at the bottom of the plunger 742.

The tip of the shaft 712a of the pen 71 has, for example, the shape of hemisphere or cone as described later. As the hollow 742a receives the tip of the shaft 712a, the shaft 712a and the pen 71 can be vertically pushed down in a stable manner.

The shape of the part to receive the tip of the shaft 712a is not limited to a conical hollow.

Alternatively, for example, the tip of the shaft 712a, described later, may have a hollow, and the part to receive the tip of the shaft 712a may have the shape of, for example, hemisphere or cone.

The configuration of the carriage rotating mechanism to rotate the carriage 72 and the configuration of the pen up-and-down mechanism to push the pen 71 down are not limited to those shown above as an example.

The carriage rotating mechanism may be constituted of, for example, a ratchet mechanism and solenoid.

In this embodiment, the rotary solenoid 443 can rotate the shaft 442 about its axis both forward and reversely.

Operation of the rotary solenoid 443 in accordance with the control of a drawing controller (not shown) rotates the shaft 442 of the rotary solenoid 443, enabling forward and reverse rotation of the head support member 441, which is fixed to the shaft 442.

Such a configuration allows the drawing head 70 supported by the head support member 441 to rotate about the axis of the shaft 442, enabling the adjustment of the tilt angle of the drawing head 70 to the surface of a nail T in the width direction of the nail T.

Similarly to the first embodiment, the rotary solenoid 443 serves as an angle changing unit to tilt the drawing head 70 to perform a stirring operation. Specifically, the rotary solenoid 443 allows the ink in the pen shafts 713a or ink containers to be stirred by tilting the drawing head 70 before the drawing head 70 performs drawing.

At the time of drawing, the rotary solenoid 443 is operated to adjust the angle of the drawing head 70 in accordance with the inclination angle of the surface of a nail T.

For example, the drawing head 70 is substantially perpendicular to the X-Y plane in an initial state in which the rotary solenoid 443 is not being driven.

The tilt angle of the drawing head 70 in the initial state in which the drawing head 70 is substantially perpendicular to the X-Y plane is defined as “0°”. FIG. 9A shows the drawing head 70 rotated by the rotary solenoid 443 from the initial state to the tilt angle over “90°” (e.g., “95°”, indicated by two-dot chain lines in FIG. 9A, in which state the drawing head 70 has been rotated more largely than to the position where the drawing head 70 is parallel to the X-Y plane, and in which state the upper part of the drawing head 70 is below the level of the lower part of the drawing head 70). FIG. 9A also shows the drawing head 70 tilted at “47.5°” between the “0°” and “95°” (indicated by solid lines in FIG. 9A).

Swinging the drawing head 70 between the tilt angles “0°” and “95°”, for example, can stir the ink in the pen shafts 713a.

The angles at which the drawing head 70 is tilted in the stirring operation are not limited to the example shown above, as in the case of the first embodiment.

For example, as shown in FIG. 9B, the operation of the rotary solenoid 443 may rotate the drawing head 70 from the initial state (tilt angle: “0°”) rightward at the tilt angle “95°”, and then leftward at the tilt angle “−95°”.

Since the other configurations are the same as those of the first embodiment, the same components are indicated by the same reference numbers/alphabets, and the explanations for such components are omitted.

The operation for the drawing with the drawing apparatus in this embodiment will now be described.

Before the start of the drawing, the drawing controller 815 operates the rotary solenoid 443 to rotate the shaft 442 about its axis to tilt (swing) the drawing head 70 from the tilt angle “0°” to the tilt angle “95°” one or more times, in the same manner as the first embodiment.

This operation stirs the ink in the pen shafts 713a or ink containers.

Next, the carriage 72 is moved to the pen warm-up section 61 for warm-up drawing.

After the completion of the ink stirring operation and the completion of the warm-up drawing, the drawing controller 815 outputs the drawing data to the drawing unit 7 and allows the drawing head 70 to perform drawing based on the drawing data.

Specifically, the drawing controller 815 selects a pen 71 to be used for drawing and rotates the carriage 72 for the selected pen 71 to be disposed below the pen up-and-down mechanism 74.

When the pen 71 is below the pen up-and-down mechanism 74, the pen up-and-down mechanism 74 pushes the pen 71 down to a position where the pen tip 713b touches the surface of a nail T.

The pen tip 713b of the pen 71 thus touches and presses the surface of the nail T with an appropriate force, which is a drawing state.

In performing drawing, the drawing controller 815 controls the operation of the rotary solenoid 443 to adjust the angle of the drawing head 70 (or the pens 71 held by the drawing head 70) to the X-Y plane in accordance with the inclination angle of the surface of the nail T.

The drawing operation may be interrupted in mid-course for the stirring operation to be performed as appropriate when there is a risk of settlement and aggregation in ink in the middle of the drawing, such as the case in which an ink prone to cause settlement (e.g., pigment) is used for the drawing or the case in which the drawing lasts for a long time.

For example, if a plurality of design parts are to be drawn on a base ink applied to the nail T, the stirring operation may be performed when the application of the base is completed and/or each time the drawing of a design part is completed.

The drawing operation may be interrupted for the stirring operation to be performed each time a predetermined time has elapsed since the start of the drawing.

Since the other operations are the same as those in the first embodiment, the explanations for them are omitted.

As described above, the second embodiment can bring about the following advantageous effects as well as the same advantageous effects as those of the first embodiment.

In the second embodiment, a plurality of (a maximum of four in this embodiment) pens 71 can be held at one time to perform drawing.

Accordingly, complex and delicate designs requiring multiple ink colors, such as complex patterns requiring multiple colors and gradation patterns requiring a plurality of inks having gradually different densities, can be easily drawn.

### Third Embodiment

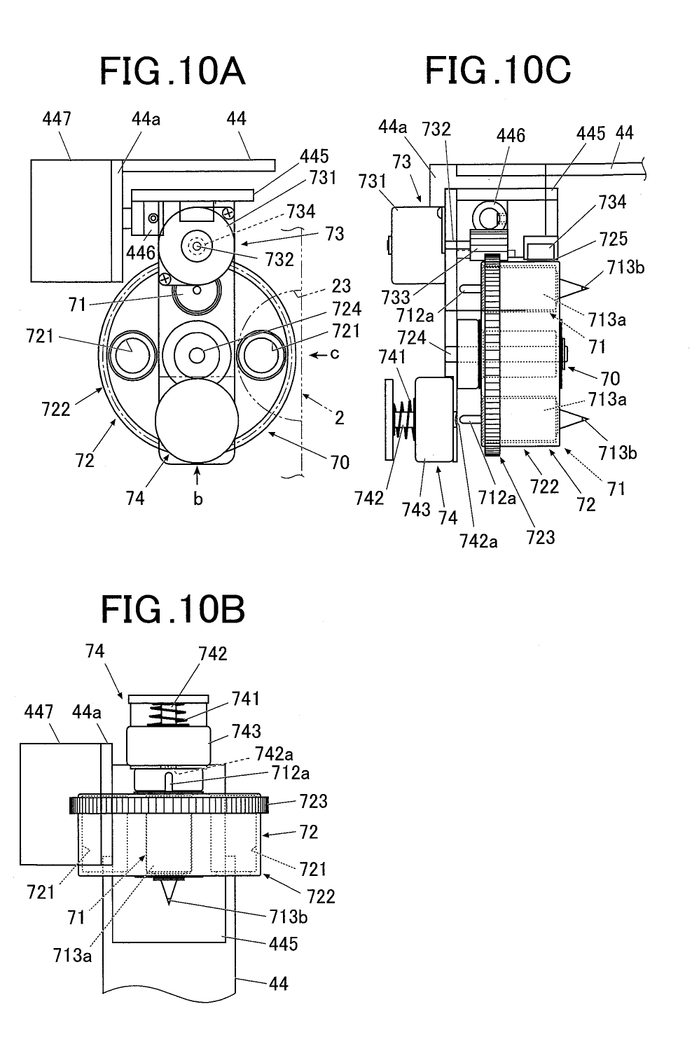

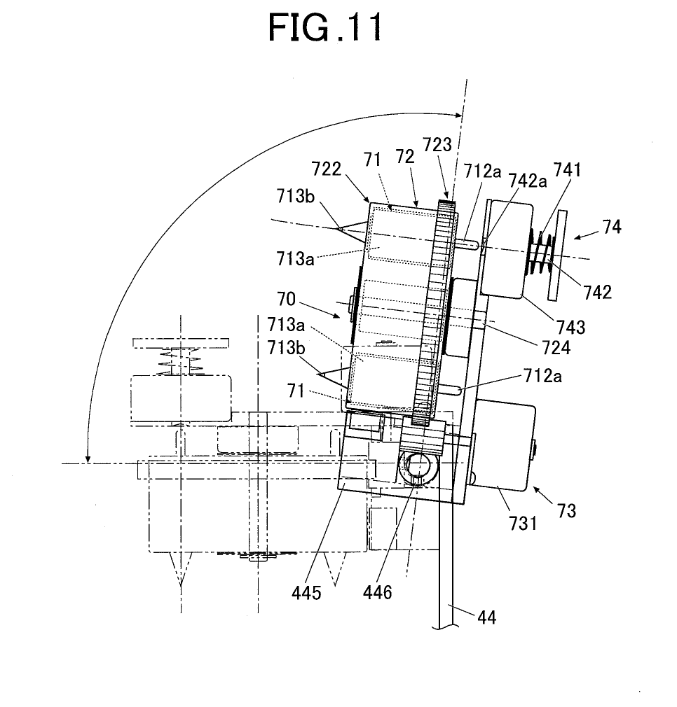

A drawing apparatus of a third embodiment of the present invention will now be described with reference to FIGS. 10 and 11.

The third embodiment is different from the first and second embodiments in the position of a rotary solenoid, and the features of the third embodiment different from those of the first and second embodiments will be described below in particular.

FIG. 10A is a top view of a drawing head 70.

FIG. 10B is a front view of the drawing head 70, seen from the direction of arrow b of FIG. 10A.

FIG. 10C is a side view of the drawing head 70, seen from the direction of arrow c of FIG. 10A.

As shown in FIGS. 10A to 10C, the drawing head 70 of the third embodiment includes a rotary carriage 72 that can hold a plurality of pens 71, similarly to the second embodiment.

In this embodiment, the drawing head 70 is supported by a head support member 445.

The unit support member 44 of this embodiment includes a projecting part 44a disposed beside the head support member 445. The unit support member 44 has the shape of an “L” when seen from above (see FIG. 10A).

The projecting part 44a of the unit support member 44 is connected to the side part of the head support member 445 through a shaft 446.

A rotary solenoid 447 is connected to the shaft 446 through the projecting part 44a.

When the rotary solenoid 447 rotates the shaft 446 about its axis, the head support member 445 and the drawing head 70 supported by the head support member 445 are tilted in the up-and-down direction (i.e., the up-and-down direction in FIG. 10C).

In other words, the rotary solenoid 447 in this embodiment can adjust the angle of the drawing head 70 to the surface of a nail T in the lengthwise direction perpendicular to the width direction of the nail T.

Similarly to the first embodiment, the rotary solenoid 447 serves as an angle changing unit to tilt the drawing head 70 to perform a stirring operation. Specifically, the rotary solenoid 447 allows the ink in the pen shafts 713a or ink containers to be stirred by tilting the drawing head 70 before the drawing head 70 performs drawing.

For example, the pens 71 (or the ink containers in the pens 71) held by the drawing head 70 are substantially perpendicular to the X-Y plane in an initial state in which the rotary solenoid 447 is not being driven.

The tilt angle of the drawing head 70 in the initial state in which the pens 71 or the ink containers in the pens 71 are substantially perpendicular to the X-Y plane is defined as “0°”. FIG. 11 shows the drawing head 70 rotated by the rotary solenoid 447 from the initial state (indicated by two-dot chain lines in FIG. 11) to the tilt angle over “90°” (e.g., “95°”, indicated by solid lines in FIG. 11, in which state the pens 71 or ink containers have been rotated more largely than to the position where the pens 71 or ink containers are parallel to the X-Y plane, and in which state the upper parts of the pens 71 or ink containers are below the level of the lower parts of the pens 71 or ink containers).

Swinging the drawing head 70 between the tilt angles “0°” and “95°”, for example, can stir the ink in the pen shafts 713a.

The angles at which the drawing head 70 is tilted in the stirring operation are not limited to the example shown above.

For example, the operation of the rotary solenoid 447 may tilt the drawing head 70 from the initial state in which the tilt angle is “0°” to a larger tilt angle, such as “100°”.

Since the other configurations are the same as those of the first and second embodiments, the same components are indicated by the same reference numbers/alphabets, and the explanations for such components are omitted.

The operation for the drawing with the drawing apparatus in this embodiment will now be described.

Before the start of the drawing, the drawing controller 815 operates the rotary solenoid 447 to rotate the shaft 446 about its axis to tilt (swing) the drawing head 70 from the tilt angle “0°” to the tilt angle “95°” one or more times, in the same manner as the first embodiment.

This operation stirs the ink in the pen shafts 713a or ink containers.

Next, the carriage 72 is moved to the pen warm-up section 61 for warm-up drawing.

After the completion of the ink stirring operation and the completion of the warm-up drawing, the drawing controller 815 outputs the drawing data to the drawing unit 7 and allows the drawing head 70 to perform drawing based on the drawing data.

Specifically, the drawing controller 815 selects a pen 71 to be used for drawing and rotates the carriage 72 for the selected pen 71 to be disposed below the pen up-and-down mechanism 74.

When the pen 71 is below the pen up-and-down mechanism 74, the pen up-and-down mechanism 74 pushes the pen 71 down to a position where the pen tip 713b touches the surface of a nail T. The pen tip 713b of the pen 71 thus touches and presses the surface of the nail T with an appropriate force, which is a drawing state.

The drawing operation may be interrupted in mid-course for the stirring operation to be performed as appropriate when there is a risk of settlement and aggregation in ink in the middle of the drawing, such as the case in which an ink prone to cause settlement (e.g., pigment) is used for the drawing or the case in which the drawing lasts for a long time.

For example, if a plurality of design parts are to be drawn on a base ink applied to the nail T, the stirring operation may be performed when the application of the base is completed and/or each time the drawing of a design part is completed.

The drawing operation may be interrupted for the stirring operation to be performed each time a predetermined time has elapsed since the start of the drawing.

Since the other operations are the same as those in the first and second embodiments, the explanations for them are omitted.

As described above, the third embodiment can bring about the following advantageous effects as well as the same advantageous effects as those of the first embodiment.

In the third embodiment, a plurality of (a maximum of four in this embodiment) pens 71 can be held at one time to perform drawing in the same manner as the second embodiment. Accordingly, complex and delicate designs requiring multiple ink colors, such as complex patterns requiring multiple colors and gradation patterns requiring a plurality of inks having gradually different densities, can be easily drawn.

The rotary solenoid 447, which is an angle changing unit, can adjust the angle of the drawing head 70 to the surface of a nail T in the lengthwise direction perpendicular to the width direction of the nail T.

The unit support member 44 is provided with a mechanism to make an adjustment in the height direction (i.e., the up-and-down direction in FIG. 10B) and can tilt the drawing head 70 by the rotary solenoid 447. This enables excellent drawing on even a nail T inclining in the lengthwise direction (e.g., a nail T whose tip part is extremely curved) and achieves drawing with a beautiful finish to the edge of the nail T.

It should be understood that the present invention is not limited to the above-described embodiments but may be modified in various manners without departing from the spirit of the invention.

For example, in the embodiments described above, the drawing apparatus 1 is a plotter printing apparatus including the drawing head 70 with a pen(s) 71 to perform drawing on the nail T of a printing finger U1. The drawing head 70 of the drawing unit 7 is not necessarily the one having a pen(s) 71.

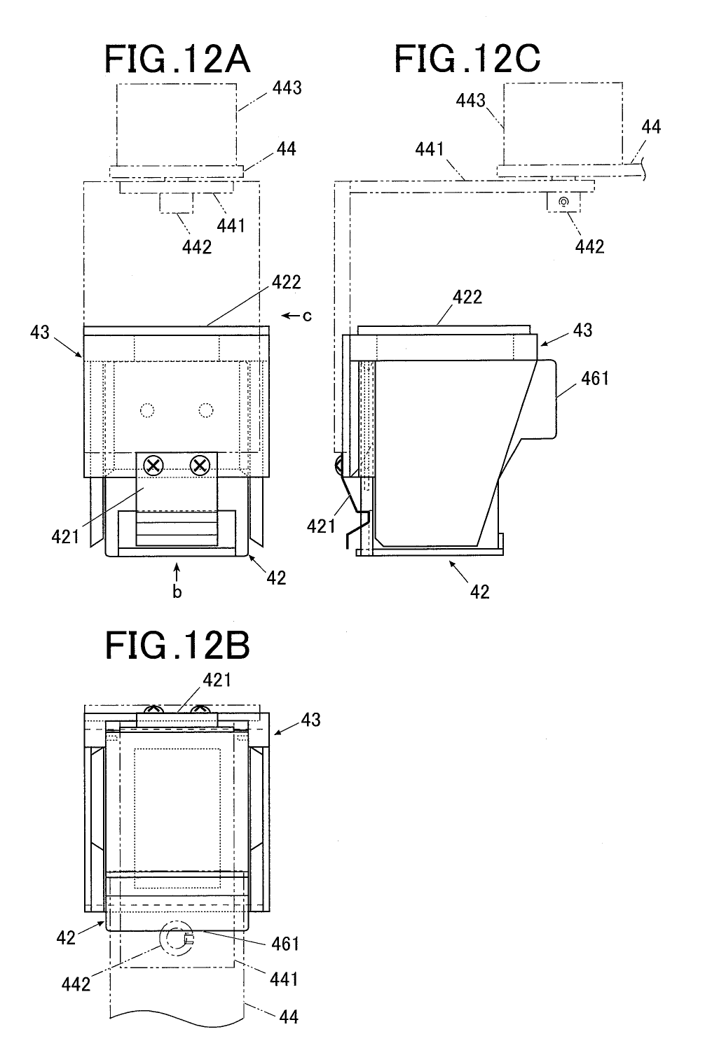

For example, the apparatus may have an ink-jet drawing head 42 shown in FIGS. 12A to 12C.

The configuration of the ink-jet drawing head 42 will now be described with reference to FIGS. 12A to 12C.

FIG. 12A is a top view of an ink-jet drawing head 42 and the periphery of the drawing head.

FIG. 12B is a front view of the drawing head 42, seen from the direction of arrow b of FIG. 12A.

FIG. 12C is a side view of the drawing head 42, seen from the direction of arrow c of FIG. 12A.

As shown in FIG. 12A to 12C, a carriage 43 to hold the drawing head 42 is attached to a head support member 441 connected to a unit support member 44 through a shaft 442 of a rotary solenoid 443.

A head drive circuit board 422 to drive the drawing head 42 is provided on the back side (i.e., the back side of the drawing apparatus or upper side in FIGS. 12A and 12C) of the carriage 43, with a connector (not shown) exposed on the inner side of the carriage 43.

A head fixation spring 421 is fixed to the upper side of the carriage 43 with screws.

The head fixation spring 421, which is, for example, a plate spring, touches the upper side of the drawing head 42 attached to the carriage 43 to fix the drawing head 42.

A recess into which the head fixation spring 421 fits is formed in the upper surface of the drawing head 42. The drawing head 42 is positioned and fixed in the carriage 43 by squeezing the drawing head 42 in the carriage 43 until the head fixation spring 421 fits into the recess.

A connector (not-shown) to be connected to the connector of the head drive circuit board 422 is provided on the back surface (i.e., the upper side in FIGS. 12A and 12C) of the drawing head 42.

The connector of the drawing head 42 is connected to the connector of the head drive circuit board 422 in the state in which the drawing head 42 is positioned by the head fixation spring 421 and fixed in the carriage 43. This allows the drawing head 42 to be driven.

The drawing head 42 can be removed from the carriage 43 by pulling up the free end of the head fixation spring 421 to put the head fixation spring 421 out of the recess of the drawing head 42 and pulling the drawing head 42 toward the front side of the carriage 43 (i.e., front side of the drawing apparatus or lower side in FIGS. 12A and 12C).

The drawing head 42 is an integrated cartridge integrated with an ink tank or ink container. Individually segmented ink chambers are provided in the drawing head 42. The ink chambers are respectively filled with inks of C, M, and Y.

The types and number of inks are not limited to the example shown above. The ink may be a UV ink-jet ink or an ink containing a white pigment.

In the case of an ink-jet white ink, the white pigment contained in the ink has a particle size of about 200 nm and is prone to settle, and so an ink stirring operation is required before the start of drawing.

An ejection plane 461 having ejection holes to eject the inks of respective colors in the ink chambers is disposed on the lower surface (i.e., the surface facing the finger placement section 116a when the drawing head 42 is attached to the carriage 43, shown in the right part of FIG. 12C) of the drawing head 42.

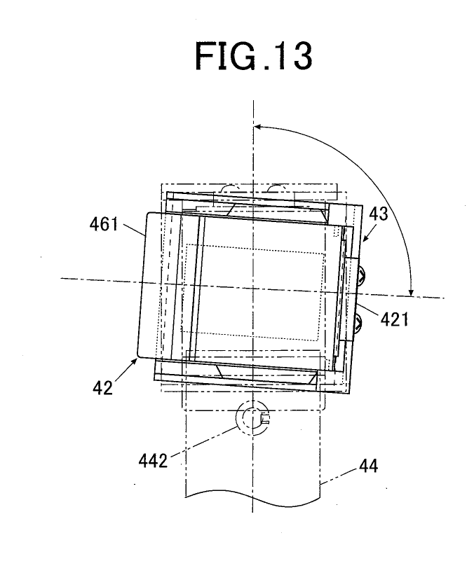

In the case of such an ink-jet drawing head 42, the drawing controller 815 controls the rotary solenoid 443 or an angle changing unit to adjust the angle of the drawing head 42 and tilt the drawing head 42 to stir the ink in the ink container before the drawing head 42 performs drawing, as shown in FIG. 13.

Even if the ink contains a pigment or coloring material having a relatively large particle size or relatively large specific gravity, such as an ink-jet white ink, which is prone to cause settlement, the stirring operation before the start of the drawing operation can prevent clogging of ink due to the settlement and aggregation in ink and achieves high-definition drawing.

At the time of drawing, the drawing controller 815 controls the rotary solenoid 443 to adjust the angle of the drawing head 42 to the X-Y plane in accordance with the inclination angle of the surface of a nail T detected by the nail information detector 812.

An ink-jet drawing head to eject fine ink drops may eject ink at a wrong position or may not be able to allow the ink to reach the edge of a nail T when the ink is ejected to the nail T diagonally.

The adjustment of the angle of the drawing head 42 to the X-Y plane allows the ink to be ejected substantially vertically to a nail T regardless of the angle of the nail T.

This enables high-definition drawing to the edge of the nail T and achieves a nail art with a beautiful finish even if the nail T has a large inclination angle, in the same manner as the case described in the above embodiments using a pen(s) 71.

In the case of the ink-jet drawing head 42, the horizontal position of the ejection plane 461 may shift when the angle of the drawing head 42 to the X-Y plane is adjusted.

Accordingly, the position of the drawing head 42 (or the position of the ejection plane 461 to eject ink) is preferably corrected before drawing is performed.

The ink stirring operation is not limited to the examples shown in the above-described embodiments, but may be performed in any method as long as the ink contained in the ink container is prevented from settling and aggregating.

For example, the operation of the rotary solenoid may operate the X-direct ion movement motor 46 while the drawing head lies substantially horizontal, so as to move the drawing head back and forth a plurality of times in the width direction (X direction) of the drawing apparatus for stirring ink.

In the first embodiment, the drawing apparatus 1 includes the carriage 43 to hold only one pen 41. The number of pens 41 held by the drawing apparatus 1, however, is not limited to one.

For example, the carriage may be a carriage which can hold more than one (e.g., four) pens 41. Increased number of holdable pens 41 can create complex nail designs with increased colors.

A mechanism to automatically replace a pen 41 held by a carriage 43 may be provided.

In this case, a plurality of pens are stored in a standby space, and a pen is automatically selected among the plurality of pens and loaded onto the carriage 43. Such a configuration allows an increased number of pens 41 to be stored in the apparatus.

The apparatus may be configure to allow a user to manually replace a pen 41 held by the carriage 43 as appropriate.

In the embodiments described above, a solenoid is used as a pen up-and-down mechanism to move the pen(s) 71 up and down. The configuration of the pen up-and-down mechanism, however, is not limited to this. A step motor, a DC motor, or a motor and ball screw may be used instead.

In the embodiments described above, the X-direction movement stage 45 and the Y-direction movement stage 47 to move the drawing head is constituted of the combination of the X-direction movement motor 46 and the Y-direction movement motor 48, which are step motors, and the ball screw and guide (not shown). The configuration to move the drawing head, however, is not limited to this.

The X-direction movement motor 46 and the Y-direction movement motor 48 may have any configuration as long as they can freely move the drawing head right and left and backwards and forwards. For example, a configuration using a mechanism constituted of shafts, guides, and wires, which are used for typical inexpensive printers; or a configuration using servomotors may be used.

In the second and third embodiments, the step motor 731 is used as a means to drive the carriage rotating mechanism 73 to rotate the carriage 72 of the drawing head 70. The configuration of the carriage rotating mechanism 73, however, is not limited to this.

For example, the carriage rotating mechanism to rotate the carriage of the drawing head may be constituted of a ratchet mechanism and solenoid etc.

In the embodiments described above, the pen contains ink for drawing. The pen held by the drawing head, however, is not necessarily the ones containing ink for drawing.

For example, a pen held by the drawing head may contain colorless/colored transparent liquid glue and apply the glue to a nail by performing drawing with the glue. After the glue is applied, power glitter may be sprinkled over or rhinestones may be attached to the nail before the glue dries up. This can produce more gorgeous nail designs.

The pens held by the drawing head may contain liquid including perfume. Drawing with such pens allows a user to enjoy nail prints with fragrance.

In the embodiments described above, a slip of paper is used as a drawing medium for the pens' warm-up drawing, but the drawing medium is not limited to a slip of paper.

Roll paper may alternatively be used as a drawing medium. In such a case, a medium sending mechanism is provided to manually or automatically feed and reel the drawing medium. In the case of such a roll drawing medium, a medium opening is provided through which the roll drawing medium is to be inserted and removed, instead of the medium insertion/output opening 24.

In the embodiments described above, the drawing data generator 813 fits the image data of a nail design to the shape of a nail T and performs curved surface correction on the image data of a nail design to generate drawing data. Generation of drawing data by the drawing data generator 813, however, is not essential for the present invention.

Alternatively, for example, the image data of a nail design may be converted as appropriate using a lookup table (LUT) in the drawing controller 815 without separate generation of drawing data. In this case, the converted data is output to the drawing head and drawing control is performed for a drawing suitable for the nail shape.

In the embodiments described above, the shape of a nail T is detected as nail information, and drawing data is generated on the basis of the detected shape. Detection of the nail shape, however, is not essential for the present invention.

In a case in which extraction of the contour of a nail T is not essential, such as a case of drawing a small design mark in the middle of a nail T, accurate recognition of a nail shape is not necessary, and drawing can be performed without the detection of a nail shape.

The photographing device is not limited to the cameras 51 which take still images but may be a camera to take moving images.

In this case, the camera shoots a moving image, and the top view of the nail T is captured as appropriate from the taken moving image to be used for the detection of nail information.

In the embodiments described above, the nail image storage area 821, the nail information storage area 822, and the nail design storage area 823 are provided in the storage unit 82 of the control device 80. These storage areas 821, 822, and 823, however, do not necessarily have to be provided in the storage unit 82 of the control device 80, but another storage unit may be provided for these storage areas 821, 822, and 823.

In the embodiments described above, fingers are inserted in the drawing apparatus 1 one by one so that drawing is performed on the fingers one by one. The present invention, however, may also be applied to a drawing apparatus that can perform drawing on multiple fingers in succession without requiring a user to insert and pull out the fingers one by one.

In this case, for example, the range within which a pen(s) is movable is increased to achieve larger-range drawing, so that the drawing is performed for multiple printing fingers U1 in succession with the printing fingers U1 inserted at a time.

Although various exemplary embodiments of the present invention have been shown and described, the invention is not limited to the embodiments shown but covers the scope of the claims and its equivalents.

What is claimed is:

1. A drawing apparatus comprising:
a drawing head to hold at least one drawing tool, the drawing tool including a fluid material container to contain a fluid material and performing drawing on a drawing target with the fluid material; and
a stirring unit which performs a stirring operation to stir the fluid material in the fluid material container of the drawing tool held by the drawing head by changing a tilt angle of the drawing tool.

2. The drawing apparatus according to claim 1, wherein
the drawing target is a nail of a finger or toe.

3. The drawing apparatus according to claim 1, wherein
the stirring unit includes an angle changing unit to change a tilt angle of the drawing head;
the stirring unit performs the stirring operation by changing the tilt angle of the drawing head with the angle changing unit; and
the angle changing unit makes (i) the tilt angle of the drawing head at a time when the stirring unit performs the stirring operation and (ii) the tilt angle of the drawing head at a time when the drawing tool performs the drawing different from each other.

4. The drawing apparatus according to claim 3, wherein
the fluid material container of the drawing tool has one end part and other end part opposite to the one end part; and
when the stirring unit performs the stirring operation, the stirring unit tilts the drawing head with the angle changing unit at (i) a first tilt angle where the one end part of the fluid material container is below a level of the other end part and (ii) a second tilt angle where the one end part of the fluid material container is above a level of the other end part.

5. The drawing apparatus according to claim 4, wherein
when the stirring unit performs the stirring operation, the stirring unit tilts the drawing head with the angle changing unit at the first tilt angle and the second tilt angle a plurality of times.

6. The drawing apparatus according to claim 1, wherein
the stirring unit performs the stirring operation before the drawing tool starts the drawing.

7. The drawing apparatus according to claim 1, wherein
while the drawing tool performs the drawing, the stirring unit interrupts the drawing to perform the stirring operation each time a predetermined time elapses.

8. The drawing apparatus according to claim 1, wherein
the drawing tool includes a shaft and a tip on one end of the shaft;
the fluid material container is disposed in the shaft; and
the drawing tool performs the drawing by applying the fluid material to a drawing target surface of the drawing target when the tip touches the drawing target surface.

9. The drawing apparatus according to claim 4, wherein
the drawing head includes a rotary carriage to hold a plurality of drawing tools,
a specific drawing tool to be used for the drawing is selected from among the drawing tools held by the rotary carriage; and
the angle changing unit tilts the rotary carriage.

10. The drawing apparatus according to claim 1, wherein
the fluid material contains a pigment having a particle size of 200 nm to 400 nm or a glitter having a particle size of 100 μm to 200 μm.

11. The drawing apparatus according to claim 3, wherein
a drawing target surface of the drawing target on which the drawing is to be performed has a curved shape with a center part of the drawing target surface above a level of both ends of the drawing target surface in a width direction; and
when the drawing is performed, the angle changing unit changes the tilt angle of the drawing head to an angle corresponding to the curved shape of the drawing target surface.

12. The drawing apparatus according to claim 11, wherein
when the drawing head performs the drawing on an area of both end parts of the drawing target surface in the width direction, the angle changing unit changes the tilt angle so that an angle of the drawing head to the drawing target surface in the width direction is close to an angle of the drawing head to the drawing target surface in the width direction at a time when the drawing head performs the drawing on the center part of the drawing target surface in the width direction.

13. A control method for drawing with a drawing apparatus, the method comprising:
holding at least one drawing tool with a drawing head, the drawing tool including a fluid material container to contain a fluid material and performing drawing on a drawing target with the fluid material;
performing a stirring operation to stir the fluid material in the fluid material container of the drawing tool held by the drawing head by changing a tilt angle of the drawing tool; and
performing the drawing on the drawing target with the drawing tool through the drawing head after the stirring operation is performed.

14. The control method for drawing with the drawing apparatus according to claim 13, wherein
the drawing apparatus includes an angle changing unit to change a tilt angle of the drawing head; and
the stirring operation includes changing the tilt angle of the drawing head with the angle changing unit to stir the fluid material; and
making (i) the tilt angle of the drawing head at a time when the stirring operation is performed and (ii) the tilt angle of the drawing head at a time when the drawing tool performs the drawing different from each other.

15. The control method for drawing with the drawing apparatus according to claim 14, wherein
the fluid material container of the drawing tool has one end part and other end part opposite to the one end part; and
the stirring operation includes tilting the drawing head with the angle changing unit at (i) a first tilt angle where the one end part of the fluid material container is below a level of the other end part and (ii) a second tilt angle where the one end part of the fluid material container is above a level of the other end part.

16. The control method for drawing with the drawing apparatus according to claim 15, wherein
the stirring operation includes tilting the drawing head with the angle changing unit at the first tilt angle and the second tilt angle a plurality of times.

17. The control method for drawing with the drawing apparatus according to claim 14, wherein
a drawing target surface of the drawing target on which the drawing is to be performed has a curved shape with a center part of the drawing target surface above a level of both ends of the drawing target surface in a width direction; and
the method comprises changing the tilt angle of the drawing head with the angle changing unit to an angle corresponding to the curved shape of the drawing target surface when the drawing is performed.

18. The control method for drawing with the drawing apparatus according to claim 13, wherein
the stirring operation is performed before the drawing tool starts the drawing.

19. The control method for drawing with the drawing apparatus according to claim 13, wherein
while the drawing tool performs the drawing, the drawing is interrupted for the stirring operation to be performed each time a predetermined time elapses.
